(19) United States
(12) Patent Application Publication
(10) Pub. No.: US 2026/0261306 A1
(43) Pub. Date: Sep. 3, 2026

(54) CSI REPORTS BASED ON ML TECHNIQUES

(71) Applicant: Google LLC, Mountain View, CA (US)

(72) Inventors: Yushu Zhang, Beijing (CN); Chih-Hsiang Wu, Taipei City (TW)

(21) Appl. No.: 18/994,557

(22) PCT Filed: Aug. 12, 2022
(86) PCT No.: PCT/CN2022/112193

§ 371 Date: Jan. 14, 2025

(51) Int. Cl. H04B 7/06; H04L 41/16

(52) U.S. Cl. CPC H04B 7/0626; H04L 41/16

(57) ABSTRACT

This disclosure describes CSI reports based on ML techniques. A UE receives one or more CSI-RSs from a network entity for generating one or more CSI reports. When at least one CSI report is based on an ML model, the UE may compress the at least one CSI report with a selected wideband precoder using one or more subband eigenvectors for one or more precoded estimated subband channels. The UE may also omit at least a portion of the at least one CSI report when a total payload size of the one or more CSI reports exceeds a threshold. The UE may be configured for parallel processing of a plurality of CSI reports that are based on the ML model and/or parallel processing of a first CSI report based on the ML model and a second CSI report that is not based on the ML model.

### TECHNICAL FIELD

The present disclosure relates generally to wireless communication, and more particularly, to channel state information (CSI) reports based on machine learning (ML) techniques.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. As mobile broadband technologies evolve, improvements in mobile broadband have been useful to continue the progression of such technologies. For example, user equipments (UEs) and base stations can support more antenna configurations and multi-connectivity. One consequence, however, is that channel state information (CSI) reports have become larger and more complex.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A user equipment (UE) may receive one or more channel state information-reference signals (CSI-RSs) from a network entity, such as a base station, for generating one or more channel state information (CST) reports. In some cases, the UE may generate at least one CSI report based on a machine learning (ML) model. Hence, the UE may include a UE capability for parallel processing of a plurality of CSI reports based on ML model(s) and/or parallel processing of a first CSI report based on the ML model and a second CSI report that is not based on the ML model.

The UE may use an ML model to reduce a complexity of the at least one CSI report by compressing the at least one CSI report using one or more subband eigenvectors. Additionally or alternatively, the UE may leverage the ML model to omit at least a portion of the at least one CSI report when a total payload size of the one or more CSI reports exceeds a threshold.

According to some aspects, a UE receives a CSI-RS from a network entity and selects a wideband precoder for compression of a CSI report based on a measurement of the CSI-RS. Selection of the wideband precoder is based on a whole bandwidth for receiving the CSI-RS. The UE compresses, with the selected wideband precoder, the CSI report using one or more subband eigenvectors for one or more precoded estimated subband channels. The UE transmits/sends, to the network entity, a first precoding matrix indicator (PMI) that indicates the wideband precoder and a second PMI that indicates the one or more subband eigenvectors.

A network entity transmits a CSI-RS to a UE for selection of a wideband precoder that compresses a CSI report based on a measurement of the CSI-RS. The selection of the wideband precoder is based on a whole bandwidth for transmitting the CSI-RS. The network entity receives, from the UE, the CSI report compressed with the selected wideband precoder using one or more subband eigenvectors for one or more precoded subband channels, a first PMI that indicates the wideband precoder, and a second PMI that indicates the one or more subband eigenvectors. The network entity decompresses the CSI report using the first PMI and the second PMI as inputs to an ML model that outputs the decompressed CSI report.

According to some aspects, the UE receives one or more CSI-RSs from a network entity for transmission of one or more CSI reports to the network entity. At least one CSI report of the one or more CSI reports is based on an ML model. When a total payload size of the one or more CSI reports exceeds a threshold, the UE omits at least a portion of the at least one CSI report based on the ML model output. The UE transmits, to the network entity, the one or more CSI reports with the at least the portion of the at least one CSI report omitted from the transmission.

According to some aspects, the UE receives, from a network entity, a configuration for a CSI report processing procedure. The configuration is for at least one of: (a) processing a plurality of CSI reports using an ML model or (b) processing a first set of CSI reports, and not a second set of CSI reports, using the ML model. The UE receives, from the network entity, a plurality of CSI-RSs. Measurements of the plurality of CSI-RSs are based on a UE capability for the CSI report processing procedure. The UE communicates CSI reports to the network entity based on the UE capability for the CSI report processing procedure.

A network entity transmits, to a UE, a configuration for a CSI report processing procedure. The configuration is for at least one of: (a) processing a plurality of CSI reports using an ML model or (b) processing a first set of CSI reports, and not a second set of CSI reports, using the ML model. The network entity transmits, to the UE, a plurality of CSI-RSs. The UE processes measurements of the plurality of CSI-RSs based on a UE capability for the CSI report processing procedure. Based on the received CSI report, the network entity communicates with the UE.

To the accomplishment of the foregoing and related ends, the one or more aspects correspond to the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system including a plurality of network entities in communication over a plurality of cells.

FIG. 2 illustrates a diagram for example machine learning (ML)-based channel state information (CSI) compression.

FIG. 3A illustrates a first timing diagram for a first CSI processing unit duration associated with periodic/semi-persistent CSI reporting.

FIG. 3B illustrates a second timing diagram for a second CSI processing unit duration associated with aperiodic CSI reporting.

FIG. 4 illustrates a diagram of a general procedure for the low complexity machine learning based CSI compression.

FIG. 5 is a signaling diagram that illustrates a procedure for the low complexity based machine learning (ML) based CSI report.

FIG. 6 illustrates a method diagram of a user equipment (UE) behavior for CSI compression and report.

FIG. 7 illustrates a method diagram of a network entity behavior for CSI decompression.

FIGS. 8A-8D illustrate tables of examples ML CSI reports.

FIG. 9A illustrates a diagram of a general procedure for the CSI report with regard to CSI omission rule for some embodiments.

FIG. 9B illustrates a diagram of an alternative procedure for the CSI report with regard to CSI omission rule for some other embodiments.

FIG. 10 is a method diagram of a UE behavior to report artificial intelligence (AI)/non-AI based CSI with the CSI omission rule based on the procedure in FIG. 9A.

FIG. 11 is a method diagram of a network entity behavior to report AI/non-AI based CSI with the CSI omission rule based on the procedure in FIG. 9A.

FIG. 12 is a method diagram of the UE behavior to report AU/non-AI based CSI with the CSI omission rule based on the procedure in FIG. 9B.

FIG. 13 is a method diagram of the network entity behavior to report AI/non-AI based CSI with the CSI omission rule based on the procedure in FIG. 9B.

FIGS. 14A-14C illustrate tables for AI-based CSI reports.

FIG. 15 is a signaling diagram illustrating a procedure for a CSI processing unit (CPU) framework for AI-based CSI processing.

FIG. 16 is a method diagram of a UE behavior for the CPU framework for AI-based CSI processing.

FIG. 17 is a method diagram of a network entity behavior for the CPU framework for the AI-based CSI processing.

FIG. 18 illustrates a timing diagram for a Type2 CPU occupancy rule.

FIGS. 19A-19B illustrate example timing diagrams for the CPU occupancy rule for an AI-based periodic/semi-persistent CSI report.

FIGS. 20A-20B illustrate example timing diagrams for the CPU occupancy rule for an AI-based aperiodic CSI report.

FIG. 21 illustrates a signaling diagram for a CSI report based on a minimum processing delay.

FIG. 22 is a diagram illustrating an example of a hardware implementation for an example UE apparatus.

FIG. 23 is a diagram illustrating an example of a hardware implementation for one or more example network entities.

### DETAILED DESCRIPTION

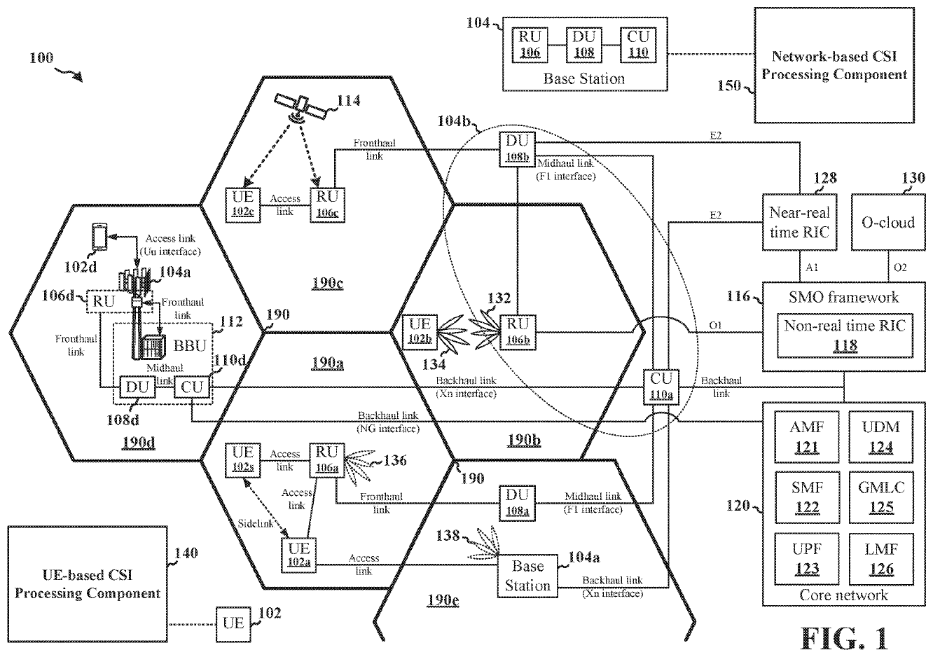

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links based on F1 interfaces. The DUs 108a-108b may respectively communicate with the RU 106a and the RUs 106b-106c via respective fronthaul links. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104a of the cell 190e simultaneously serve.

One or more CUs 110, such as the CU 110a or the CU 110d, may communicate directly with a core network 120 via a backhaul link. For example, the CU 110d communicates with the core network 120 over a backhaul link based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link based on an Xn interface. For example, the CU 110d of the base station 104a communicates with the CU 110a of the base station 104b over the backhaul link based on the Xn interface. Similarly, the base station 104a of the cell 190e may communicate with the CU 110a of the base station 104b over a backhaul link based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link between the RU 106d and the baseband unit (BBU) 112 of the cell 190d or, more specifically, the fronthaul link between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FR1 is actually grater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz 24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190c may receive the beamformed signal from the RU 106a based on a base station beam set 138 in one or more receive directions of the base station 104a. Similarly, the base station 104a of the cell 190e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals. NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a UE-based channel state information (CSI) processing component 140 configured to receive a CSI-RS from a network entity and select a wideband precoder for compression of a CSI report based on a measurement of the CSI-RS. Selection of the wideband precoder is based on a whole bandwidth for receiving the CSI-RS. The UE-based CSI processing component 140 is further configured to compress, with the selected wideband precoder, the CSI report using one or more subband eigenvectors for one or more precoded subband channels. The UE-based CSI processing component 140 is further configured to transmit/send, to the network entity for decompression of the CSI report, a first precoding matrix indicator (PMI) that indicates the wideband precoder and a second PMI that indicates the one or more subband eigenvectors.

In further examples, the UE-based CSI processing component 140 is configured to receive one or more CSI-RSs from a network entity and transmit one or more CSI reports to the network entity. The UE generates at least one CSI report of the one or more CSI reports using an ML model. When a total payload size of the one or more CSI reports exceeds a threshold the UE-based CSI processing component 140 is further configured to omit at least a portion of the at least one CSI report. The UE-based CSI processing component 140 is further configured to transmit, to the network entity, the one or more CSI reports with the at least the portion of the at least one CSI report omitted from the transmission.

In still further examples, the UE-based CSI processing component 140 is configured to receive, from a network entity, a configuration for a CSI report processing procedure. The configuration is for at least one of: (a) processing a plurality of CSI reports using an ML model or (b) processing a first set of CSI reports, and not a second set of CSI reports, using the ML model. The UE-based CSI processing component 140 is further configured to receive, from the network entity, a plurality of CSI-RSs. Measurements of the plurality of CSI-RSs are based on a UE capability for the CSI report processing procedure. The UE-based CSI processing component 140 is further configured to communicate CSI reports to the network entity based on the UE capability for the CSI report processing procedure.

In certain aspects, the base station 104 or a network entity of the base station 104 may include a network-based CSI processing component 150 configured to transmit a CSI-RS to a UE for selection of a wideband precoder that compresses a CSI report based on a measurement of the CSI-RS. The selection of the wideband precoder is based on a whole bandwidth for transmitting the CSI-RS. The network-based CSI processing component 150 is further configured to receive, from the UE, the CSI report compressed with the selected wideband precoder using one or more subband eigenvectors for one or more precoded subband channels, a first PMI that indicates the wideband precoder, and a second PMI that indicates the one or more subband eigenvectors. The network-based CSI processing component 150 is further configured to decompress the CSI report using the first PMI and the second PMI as inputs to an ML model that outputs the decompressed CSI report.

In further examples, the network-based CSI processing component 150 is configured to transmit one or more CSI-RSs to a UE for one or more CSI reports. At least one CSI report of the one or more CSI reports is based on an ML model. The network-based CSI processing component 150 is further configured to receive, from the UE, the one or more CSI reports with at least a portion of the at least one CSI report being omitted when a total payload size of the one or more CSI reports exceeds a threshold.

In still further examples, the network-based CSI processing component 150 is configured to transmit, to a UE, a configuration for a CSI report processing procedure. The configuration is for at least one of: (a) processing a plurality of CSI reports using an ML model or (b) processing a first set of CSI reports, and not a second CSI report, using the ML model. The network-based CSI processing component 150 is further configured to transmit, to the UE, a plurality of CSI-RSs. Measurements of the plurality of CSI-RSs are based on a UE capability for the CSI report processing procedure. The network-based CSI processing component 150 is further configured to communicate CSI reports to the UE based on the UE capability for the CSI report processing procedure. Although the following description may be focused on 5G NR, the concepts described herein may be applicable to other similar areas, such as 5G-Advanced and future versions, LTE, LTE-advanced (LTE-A), and other wireless technologies.

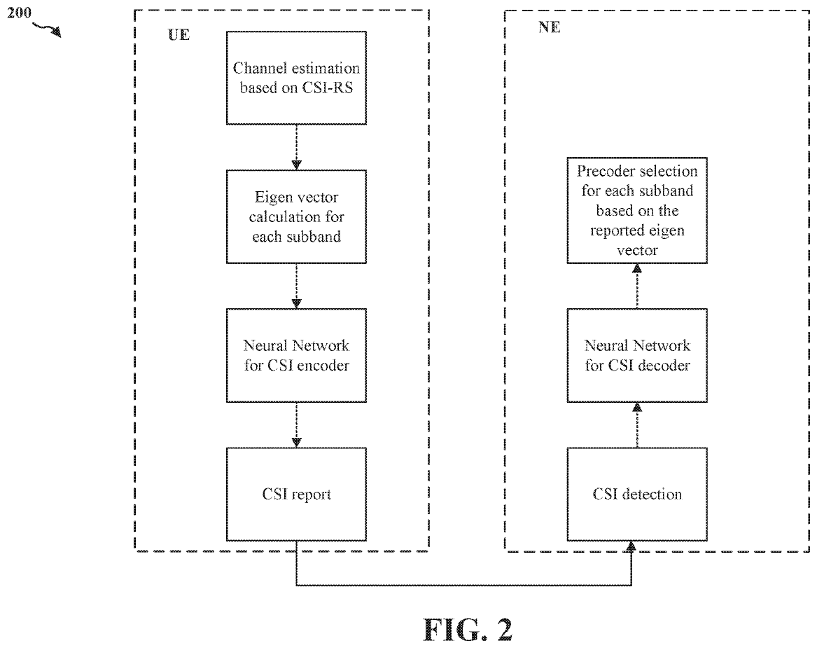

FIG. 2 illustrates a diagram 200 for example machine learning (ML)-based channel state information (CSI) compression. For a Multiple-Input Multiple-Output (MIMO) system, the CSI is a key information for a gNB to select the digital precoder for a UE. Usually a gNB can configure a CSI report by RRC signaling CSI-reportConfig, where a channel measurement resource (CMR) is used by a UE to measure a channel state information reference signal (CSI-RS) to estimate the downlink channel. Meanwhile, the gNB may configure, in a CSI-reportConfig, some interference measurement resource (IMR) for UE to measure interference. With the help of CMR and IMR, UE is able to identify the CSI, which may include rank indicator (RI), precoding matrix indicator (PMI), channel quality indicator (CQI) and layer indicator (LI). RI and PMI are used to determine a digital precoder (also called a precoding matrix), CQI is used to reflect the signal-to-interference plus noise (SINR) status so as to determine the transmitter's selection of modulation and coding scheme (MCS), and LI is used to identify the strongest layer, which can be helpful for MU-MIMO pairing with low rank transmission and the precoder selection for phase-tracking reference signal (PT-RS). A UE may report the CSI in two parts by physical uplink control channel (PUCCH)/physical uplink shared channel (PUSCH), where CSI part 1 may include RI and CQI for the first transport block (TB), and CSI part 2 may include PMI, LI and CQI for the second TB. The payload size for CSI part 2 is determined based on CSI part 1, and both parts are transmitted with separate channel coding operations.

The gNB can configure the time domain behavior, i.e. periodic/semi-persistent/aperiodic report, for a CSI report in a CSI-reportConfig. The gNB can activate or deactivate a semi-persistent CSI report by MAC control element (CE). The gNB can trigger an aperiodic CSI report by Downlink Control Information (DCI). The UE may report the periodic CSI by a PUCCH resource configured in CSI-reportConfig. UE may report the semi-persistent CSI by a PUCCH resource configured in CSI-reportConfig or PUSCH resource triggered by DCI by gNB. The UE may report the aperiodic CSI by a PUSCH resource triggered by a DCI from the gNB.

In resource element k for a CSI-RS, the receiving signal in frequency domain could be obtained as follows:

$${Y}_{k} = {H}_{k} {X}_{k} + {N}_{k}$$

where Hₖ indicates the effective channel including analog beamforming weight with the dimension of N_{Rx} by N_{Tx}, Xₖ is the CSI-RS at resource element k, Nₖ denotes the interference plus noise, N_{Rx} is the number of receiving ports and N_{Tx} is the number of transmission ports.

In resource element k for physical downlink shared channel (PDSCH), the receiving signal in frequency domain could be as follows:

$${Y}_{k} = {H}_{k} {W}_{k} {X}_{k} + {N}_{k}$$

where Wₖ indicates the precoder and usually for subcarriers within a subband (bundled physical resource block), the precoder should be the same.

Since Rel-15, the Type 2 CSI codebook is introduced for UE to measure and report the CSI, where a precoder is quantized as follows:

$$W = {W}_{1} {W}_{2}$$

where W₁ is a wideband precoder with the dimension of N_{Tx} by 2L; W₂ is a subband precoder with the dimension of 2L by v; L indicates the number of beams, and v indicates the number of layers, which is RI+I.

W₁ can be quantized based on a codebook, while W₂ could be quantized based on power and angle for each element, which could lead to a large overhead since W₂ is subband based, and there could be multiple subbands for a CSI report, which is determined by the bandwidth for the CSI-RS. In one example, the codebook for W1 selection can be defined as follows:

$${W}_{1} = [ \begin{matrix}B & 0 \\ 0 & B\end{matrix} ]$$

$$B = [ \begin{matrix}{b}_{1} & {b}_{2} & … & {b}_{L}\end{matrix} ]$$

$${b}_{l} = {u}_{m} ⊗ {v}_{n}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

where, ⊗ denotes Kronecker product; L indicates number of beams which are configured by RRC signaling; N₁, N₂, O₁, and O₂ are related to the number of ports and oversampling factor in horizontal and vertical domain, which are configured by RRC signaling, and the candidate values should be determined based on number of CSI-RS ports. The codebook contains the precoders with different value of m and n. In one example, candidate values are defined as Table 5.2.2.2.1-2 in 38.214.

Machine learning is one way to perform the CSI compression, where the first v columns of Eigen vector for the average channel for each subband can be used as the input. As used herein, unless otherwise specifically indicated, the terms “machine learning” and “artificial intelligence” may be used interchangeably with each other. FIG. 2 shows an example for machine learning based CSI compression after a UE receives the CSI-RS. The UE can estimate the channel based CSI-RS, and then calculate the Eigen vector for the channel in each subband. The Eigen vectors can be the input for the neural network for CSI compression. Then UE can report the compressed CSI to its gNB. Upon receipt, the gNB can decode the compressed CSI and then de-compress the CSI using a neural network to recover the Eigen vector.

For each subband, the Eigen vector V can be derived based on singular vector decomposition (SVD) of the average channel in the subband as follows.

$${USV}^{H} = \frac{1}{N} {\sum }_{k ∈ S} {\hat{H}}_{k}$$

Where N indicates the number of CSI-RS resource elements for subband S; Ĥₖ is the estimated channel based on CSI-RS at resource element k.

For Machine Learning (ML) based CSI compression, the corresponding terminology is defined as follows.

Data collection refers to a process of collecting data by the network nodes, management entity, or UE for the purpose of AI/ML model training, data analytics and inference.

AI/ML model refers to a data driven algorithm that applies AI/ML techniques to generate a set of outputs based on a set of inputs.

AI/ML model training refers to a process to train an AI/ML Model (e.g., by learning the input/output relationship) in a data driven manner and obtain the trained AI/ML Model for inference.

AI/ML model inference refers to a process of using a trained AI/ML model to produce a set of outputs based on a set of inputs.

AI/ML model validation refers to a sub-process of training, to evaluate the quality of an AI/ML model using a dataset different from one used for model training, that helps selecting model parameters that generalize beyond the dataset used for model training.

AI/ML model testing refers to sub-process of training, to evaluate the performance of a final AI/ML model using a dataset different from one used for model training and validation. Differently from AI/ML model validation, testing does not assume subsequent tuning of the model.

UE-side AI/ML model refers to an AI/ML Model whose inference is performed entirely at the UE.

Network-side AI/ML model refers to an AI/ML Model whose inference is performed entirely at the network.

One-sided AI/ML model refers to a UE-side AI/ML model or a Network-side AI/ML model.

Two-sided AI/ML model refers to a paired AI/ML Model(s) over which joint inference is performed, where joint inference comprises AI/ML Inference whose inference is performed jointly across the UE and the network, i.e., the first part of inference is firstly performed by UE and then the remaining part is performed by gNB, or vice versa.

AI/ML model transfer refers to delivery of an AI/ML model over the air interface, either parameters of a model structure known at the receiving end or a new model with parameters. Delivery may contain a full model or a partial model.

Model download refers to model transfer from the network to UE.

Model upload refers to model transfer from UE to the network.

Federated learning/federated training refers to a machine learning technique that trains an AI/ML model across multiple decentralized edge nodes (e.g., UEs, gNBs) each performing local model training using local data samples. The technique requires multiple interactions of the model, but no exchange of local data samples.

Offline field data refers to the data collected from field and used for offline training of the AI/ML model

Online field data refers to the data collected from field and used for online training of the AI/ML model.

Model monitoring refers to a procedure that monitors the inference performance of the AI/ML model.

Supervised learning refers to a process of training a model from input and its corresponding labels.

Unsupervised learning refers to a process of training a model without labelled data.

Semi-supervised learning refers to a process of training a model with a mix of labelled data and unlabelled data.

Reinforcement Learning (RL) refers to a process of training an AI/ML model from input (a.k.a. state) and a feedback signal (a.k.a. reward) resulting from the model's output (a.k.a. action) in an environment the model is interacting with.

Model activation refers to enabling an AI/ML model for a specific function.

Model deactivation refers to disabling an AI/ML model for a specific function.

Model switching refers to deactivating a currently active AI/ML model and activating a different AI/ML model for a specific function.

One potential issue for current procedure in FIG. 2 is that the UE complexity for Eigen vector calculation puts considerable demands on processors within the UE. For each subband, the calculation of the first Eigen vector V₁ requires singular vector decomposition (SVD) of the average channel as follows.

$${USV}_{1}^{H} = \frac{1}{N} {\sum }_{k ∈ S} {\hat{H}}_{k}$$

where N indicates the number of CSI-RS resource elements for subband S; Ĥₖ is the estimated channel based on CSI-RS at resource element k. Usually the number of transmission ports in CSI-RS could be quite large, e.g. N_{Tx}=32. Thus, the complexity for the SVD could be a problem.

Hence, a method is proposed to reduce the UE complexity for ML based CSI compression, including: Eigen vector calculation complexity reduction.

A UE may be configured with multiple CSI-reportConfig, and some may be configured based on ML. i.e. AI based CSI report, while some may be configured based on traditional codebook, i.e. non-AI based CSI report. UE may be triggered to report CSI from multiple CSI-reportConfig by PUSCH or PUCCH. Then the total payload size for the CSI may exceed the maximum payload size for CSI part 2 in the PUSCH/PUCCH. Some parts need to be omitted. For multiple AI based CSI reports or mixed AI and non-AI based CSI report, how to define the CSI omission rule could be a second problem.

Hence, a method is proposed for an AI based CSI report, including: CSI omission rule for multiple AI and non-AI based CSI reports; and CSI omission rule for a single AI based CSI report.

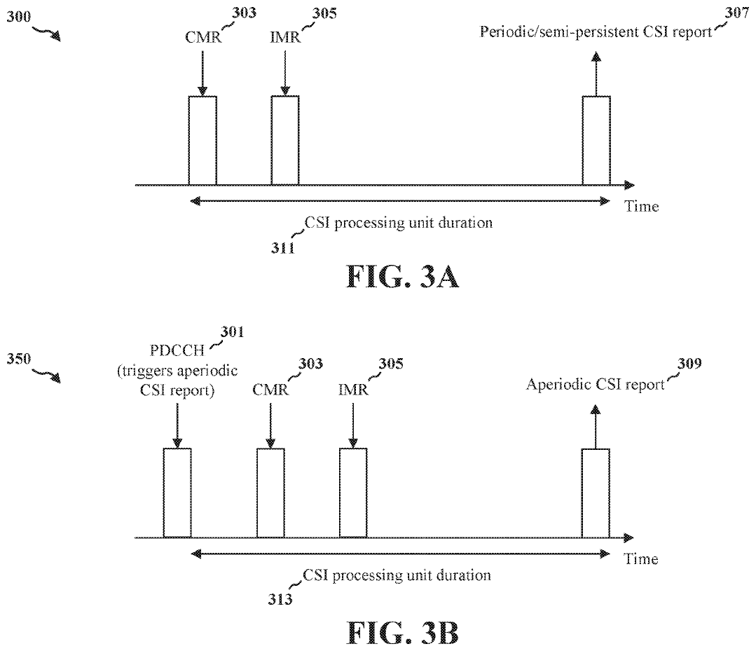

FIG. 3A illustrates a first timing diagram 300 for a first CSI processing unit duration 311 associated with periodic/semi-persistent CSI reporting. FIG. 3B illustrates a second timing diagram 350 for a second CSI processing unit duration 313 associated with aperiodic CSI reporting. The UE 102 can be configured with multiple CSI-reportConfig information elements (IEs) for multiple CSI measurements and reports. Thus, a plurality of CSI processing units may be used for parallel processing of received CSI-RS to create a plurality of CSI measurements and reports. The UE 102 might transmit UE capability information to the base station 104 indicating a number of CSI processing units that the UE 102 supports. If the base station 104 requests CSI reports that require more parallel CSI processing at the UE 102 than the number of CSI processing units available at the UE (i.e., indicated in the UE capability report), the UE 102 can report non-current information for low priority CSI reports. In some examples, the UE 102 may determine a priority of a particular CSI report based on predefined protocols. For example, a CSI processing unit occupancy rule for the periodic/semi-persistent CSI report 307 and the aperiodic CSI report 309 may be based on the predefined protocols.

The first CSI processing unit duration 311 for the periodic/semi-persistent CSI report 307 corresponds to a CSI processing unit that's occupancy begins at a first symbol of earliest resources for the CMR 303 or the IMR 305 used for measurements by the UE 102. For example, the UE 102 may perform one or more measurements of a CSI-RS, CSI-interference measurement (CSI-IM), a synchronization signal block (SSB), etc. The first CSI processing unit duration 311 for the periodic/semi-persistent CSI report 307 continues through last resources for the CMR 303 and the IMR 305 used for the measurement of the UE 102 and ends at a last symbol of a PUSCH/PUCCH used by the UE 102 for transmitting the periodic/semi-persistent CSI report 307 to the base station 104.

The second CSI processing unit duration 313 for the aperiodic CSI report 309 corresponds to a CSI processing unit that's occupancy begins at a first symbol after receiving a physical downlink control channel (PDCCH) 301 that triggers the aperiodic CSI report 309. The second CSI processing unit duration 313 for the aperiodic CSI report 309 continues through last resources for the CMR 303 and the IMR 305 used for the measurement of the UE 102 and ends at a last symbol of a PUSCH used by the UE 102 for transmitting the aperiodic CSI report 309 to the base station 104. If the PDCCH 301 that triggers the aperiodic CSI report 309 corresponds to two PDCCH candidates from two respective search space sets, the PDCCH candidate that ends later in time is used for determining the second CSI processing unit duration 313 for the aperiodic CSI report 309.

If the PDCCH 301 triggers an initial semi-persistent CSI report on the PUSCH, the CSI processing unit duration for the initial semi-persistent CSI report may not be the same as the first CSI processing unit duration 311 for the periodic/semi-persistent CSI report 307. Instead, the CSI processing unit duration for the initial semi-persistent CSI report may correspond to the second CSI processing unit duration 313 for the aperiodic CSI report 309. That is, the CSI processing unit duration for the initial semi-persistent CSI report transmitted on the PUSCH, after the PDCCH 301, begins at the first symbol after the PDCCH 301 and ends at the last symbol of the PUSCH that carries the initial semi-persistent CSI report. If the PDCCH 301 that triggers the initial semi-persistent CSI report corresponds to two PDCCH candidates from two respective search space sets, the PDCCH candidate that ends later in time is used for determining the CSI processing unit duration for the initial semi-persistent CSI report.

CSI reporting by the UE 102 might be based on a minimum processing delay time. For example, scheduling for the periodic/semi-persistent CSI report 307 or the aperiodic CSI report 309 might include minimum processing delays of Z and Z′. Values of Z and Z′ for different types of CSI reports might be based on one or more predefined protocols. If a scheduling offset does not indicate the minimum processing delays of Z and Z′, the UE 102 can report the minimum processing delay associated with the non-current CSI or disregard a triggering DCI, if no other signals (e.g. data or hybrid automatic repeat request (HARQ)-acknowledgment (ACK) (HARQ-ACK)) are to be transmitted on the PUSCH triggered by the DCI (e.g., PDCCH 301). If a CSI request field of the DCI is used to trigger one or more CSI reports from the UE 102 on the PUSCH, the UE 102 may transmit the one or more CSI reports to the base station 104, if the first uplink symbol associated with the one or more CSI reports serves as a timing advance that starts no earlier than symbol Z_{ref}. For instance, the UE 102 may transmit an n-th triggered CSI report to the base station 104, if the first uplink symbol associated with the n-th CSI report starts no earlier than symbol Z′_{ref}(n).

The AI based CSI report may be implemented by UE based on a different hardware, e.g. neural processing unit (NPU), compared to non-AI based CSI. Then a CPU may not be shared for AI based and non-AI based CSI. Thus, how to manage the parallel processing for multiple AI based CSI reports and mixed AI and non-AI based CSI reports could be one issue. Moreover, the complexity for AI based CSI report would also be determined by the ML model. Then how to define the minimal processing delay for AI based CSI report could be another issue.

Hence, a method is proposed for methods of parallel processing for AI based CSI measurement and report, including: CSI processing unit (CPU) management framework; and minimal processing delay requirement.

### Low Complexity ML-Based CSI Compression

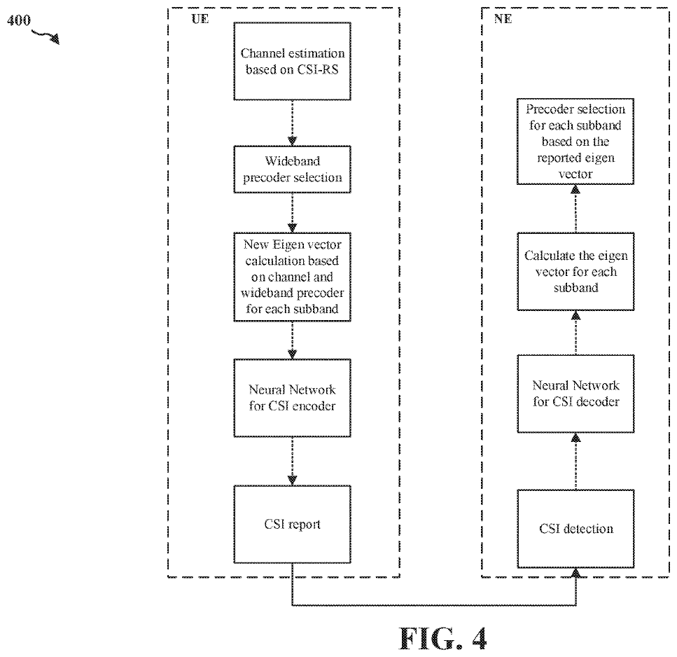

FIG. 4 illustrates a diagram 400 of a general procedure for the low complexity machine learning based CSI compression. Compared to traditional approach in FIG. 2, the input for the neural network is calculated as follows:

$${USV}_{2}^{H} = \frac{1}{N} {\sum }_{k ∈ S} {\hat{H}}_{k} {W}_{1}$$

The first v columns of the second Eigen vector V₂ could be the input of neural network, where v indicates the number of layers. W1 is the wideband precoder which can be quantized based on a predefined codebook or a codebook configured by the network entity, e.g. Type1 codebook as defined in section 5.2.2.2.1 in 3GPP TS 38.214 v17.2.0, or Type2 codebook as defined in section 5.2.2.2.3 in 3GPP TS 38.214 v17.2.0. In one example, the codebook for W1 selection can be defined as follows:

$${W}_{1} = [ \begin{matrix}B & 0 \\ 0 & B\end{matrix} ]$$

$$B = [ \begin{matrix}{b}_{1} & {b}_{2} & … & {b}_{L}\end{matrix} ]$$

$${b}_{l} = {u}_{m} ⊗ {v}_{n}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

where, ⊗ denotes Kronecker product; L indicates number of beams which are configured by RRC signaling; N₁, N₂, O₁, and O₂ are related to the number of ports and oversampling factor in horizontal and vertical domain, which are configured by RRC signaling, and the candidate values should be determined based on number of CSI-RS ports. The codebook contains the precoders with different value of m and n. In one example, candidate values are defined as Table 5.2.2.2.1-2 in 38.214.

The dimension of

$$\frac{1}{N} {\sum }_{k ∈ S} {\hat{H}}_{k} {W}_{1}$$

could be N_{Rx} by 2L, where L is configured by RRC parameter. In one example, L could be 2. Then the dimension of the input matrix for SVD could be much smaller than procedure in FIG. 2.

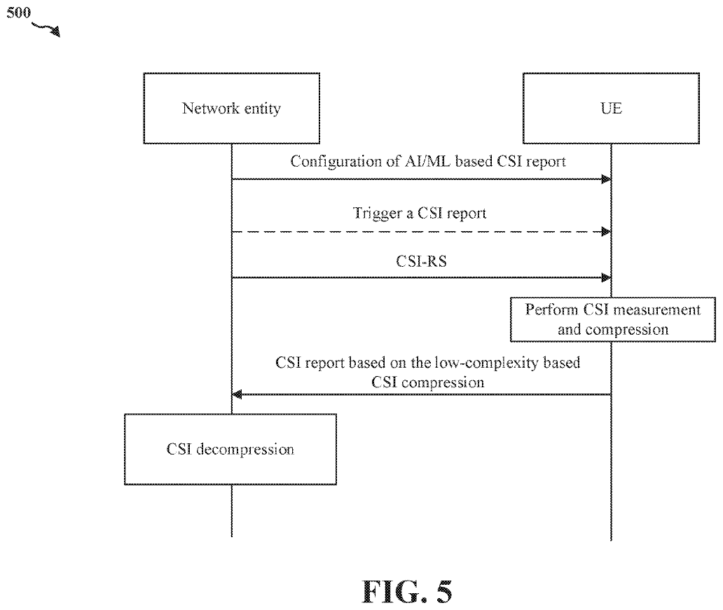

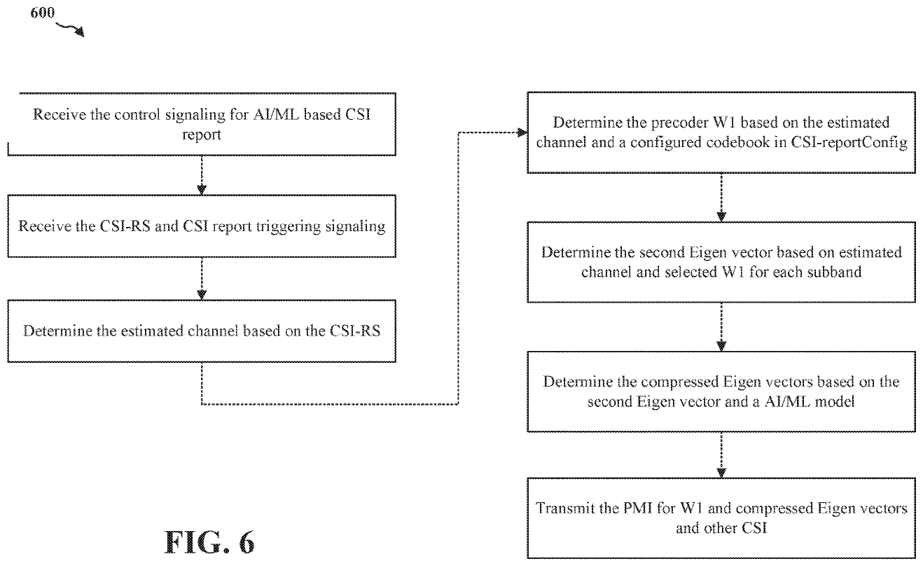

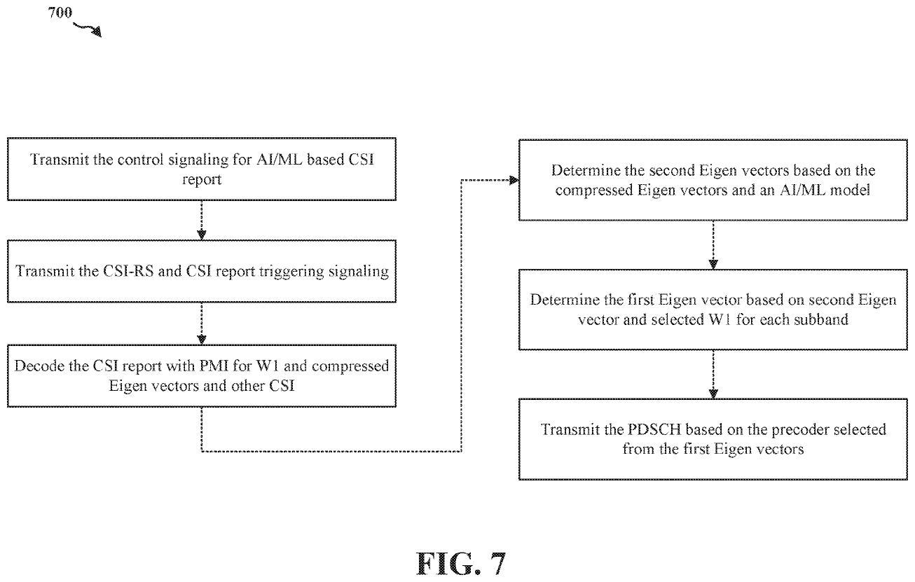

FIG. 5 is a signaling diagram 500 that illustrates a procedure for the low complexity based ML based CSI report. The gNB may provide a configuration for a ML based CSI report by RRC signaling, e.g. CSI-reportConfig. The gNB may trigger a CSI report by MAC CE or DCI. For periodic CSI report, this message can be skipped. In one example, gNB may trigger semi-persistent CSI report by MAC CE, and gNB may trigger aperiodic CSI report by DCI. UE may perform the CSI measurement based on reception of the CSI-RS. The UE may compress the CSI based on the low complexity based ML based compression operation as shown in FIG. 6, where compared to legacy approach (the first Eigen vector is used as input), a second Eigen vector is used as the input for a ML model. After CSI compression, UE may report the compressed CSI to gNB. The gNB may receive the CSI and decompress the CSI based on ML. FIG. 6 illustrates a method diagram 600 of the UE behavior for CSI compression and report. FIG. 7 illustrates a method diagram 700 of the gNB behavior for CSI decompression.

In an embodiment, the input for the neural network for CSI encoder in the UE side should be based on the selected wideband precoder and estimated channel from the CSI-RS. In one example, the input could be the first v columns of the second Eigen vector V2 calculated based on SVD of matrix

$$\frac{1}{N} {\sum }_{k ∈ S} {\hat{H}}_{k} {W}_{1} .$$

The number of beams for W1 and the codebook structure to search can be configured by higher layer signaling, e.g. RRC signaling. In one example, the codebook could be based on Type1 or Type2 CSI codebook defined in section 5.2.2.2.1 or 5.2.2.2.3 in 38.214. In one example, the codebook for W1 selection can be defined as follows:

$${W}_{1} = [ \begin{matrix}B & 0 \\ 0 & B\end{matrix} ]$$

$$B = [ \begin{matrix}{b}_{1} & {b}_{2} & … & {b}_{L}\end{matrix} ]$$

$${b}_{l} = {u}_{m} ⊗ {v}_{n}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{n} = {[ \begin{matrix}1 & {e}^{\frac{j 2 π n}{{N}_{2} {O}_{2}}} & … & {e}^{\frac{j 2 π ( {N}_{2} - 1 ) n}{{N}_{2} {O}_{2}}}\end{matrix} ]}^{T}$$

where, ⊗ denotes Kronecker product; L indicates number of beams which may be configured by RRC signaling, e.g. numberOfBeams; N₁, N₂, O₁, and O₂ are related to the number of ports and oversampling factor in horizontal and vertical domain, which are configured by RRC signaling. e.g. n1-n2, and the candidate values should be determined based on number of CSI-RS ports. The codebook contains the precoders with different value of m and n. In one example, candidate values are defined as Table 5.2.2.2.1-2 in 38.214.

The ML model(s), for CSI encoder may be configured by higher layer signaling by gNB, e.g. RRC signaling, or be predefined or preconfigured. In one implementation, different ML models may be used for different codebook structures. In one example, one ML model should be used for the codebook with a certain number of beams configured. In another example, one ML model should be used for the codebook with a certain number of beams, N₁, N₂, O₁, and O₂ configured. In another example, one ML model should be used for the codebook with a certain number of subbands, number of beams, N₁, N₂, O₁, and O₂ configured.

In some implementation, before the RRC configuration for codebook for ML based CSI report, UE may report its capability of supported codebook structure for ML based CSI report.

In an embodiment, for a AI based CSI report, the first precoder matrix index (PMI) for W1 can be reported as well as the output of the ML for CSI compression, which can be denoted as a compressed Eigen vector or a second PMI for each subband, can be reported by UE to gNB.

In one example, the first PMI may be reported as two indexes: one is used to indicate the horizontal beam index m and the other is used to indicate the vertical beam index n. The second PMI is the output for the ML model used for CSI compression.

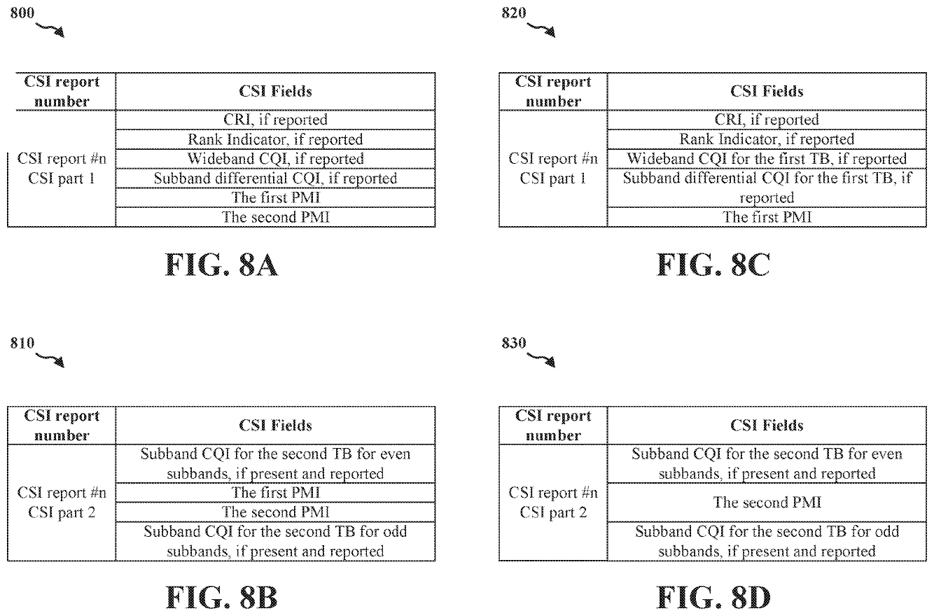

FIGS. 8A-8D illustrate tables 800-830 of examples ML CSI reports. In one implementation, for short PUCCH based CSI report, both PMIs and other CSI may be reported in a single part. Table 800 of FIG. 8A illustrates one example for ML CSI report format in short PUCCH.

In one implementation, for PUSCH or long PUCCH based CSI, both PMIs may be reported in CSI part 2, where the bit-width for CSI part 2 is determined by the information reported in CSI part 1, e.g. CRI/RI and CQI for the first transport block (TB). Table 810 of FIG. 8B illustrates another example for ML CSI report format as part 2 CSI in long PUCCH and PUSCH.

In another implementation, for PUSCH or long PUCCH based CSI, both PMIs may be reported in CSI part 2, the first PMI is reported in CSI part 1 and the second PMI is reported in CSI part 2. Table 820 of FIG. 8C and Table 830 of FIG. 8D illustrate another example for ML CSI report format as part 1 and part 2 CSI in long PUCCH and PUSCH.

In an embodiment, the low complexity based CSI compression can be enabled by RRC signaling by gNB, e.g. RRC parameter in CSI-reportConfig, which should be based on UE capability report. In one implementation, a codebook with a codebookType configured as ‘ML’ or ‘Type3’. The RRC signaling for a codebook ML may include at least one of: a number of beams (L), a number of ports in horizontal and vertical domain (N1, N2), a number of oversampling factors in horizontal and vertical domain (O1, O2), a number of subbands for CSI compressions, a number of subbands per CQI calculation, which indicates the number of subbands for CSI compression used for CQI calculation, an RI restriction, which is used to indicate the candidate ranks for precoder selection, or an ML model, which indicates the ML model used for CSI compression.

In addition, with regard to the low complexity based ML CSI compression and traditional ML, a subtype may be indicated in the codebook configuration for ML to indicate whether this is low complexity based ML, e.g. typeIII-hybrid or traditional ML, e.g. typeIII.

Unless otherwise specified herein, a RRC signaling may indicate a RRC reconfiguration message from gNB to UE, or a system information block (SIB), where the SIB can be an existing SIB (e.g., SIB1) or a new SIB transmitted by gNB. In addition, the gNB may obtain the UE capability via UE capability report signaling or from a core network (e.g., Access and Mobility Management Function (AMF)).

Further in this invention, solutions described are based on 5G NR technologies. It should be understood that the solutions can be applied to other wireless technologies such as 6G. The “gNB” can be generalized as a base station or a radio access network (RAN) node.

### CSI Omission for AI-Based CSI Report

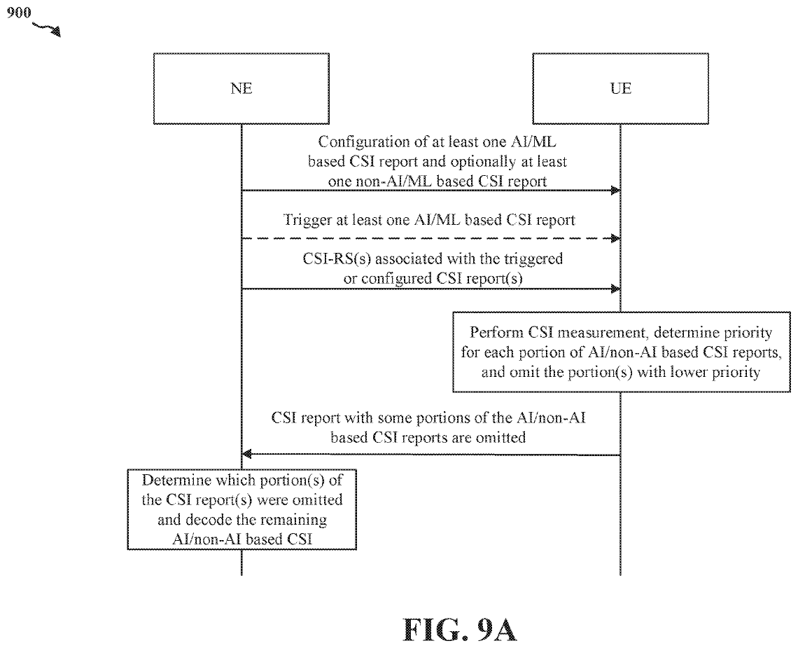

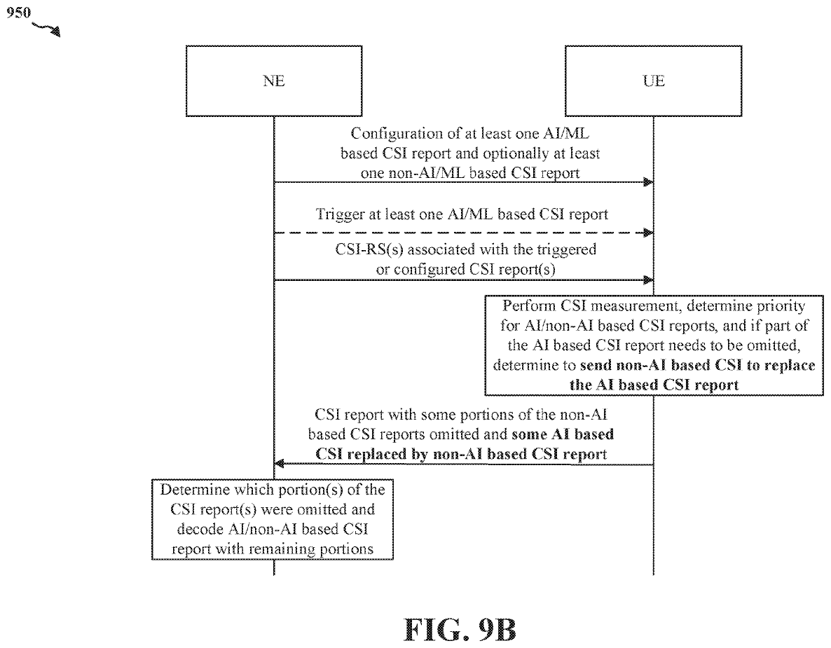

FIG. 9A illustrates a diagram 900 of a general procedure for the CSI report with regard to CSI omission rule for some embodiments. When the overhead for CSI for multiple CSI reports exceed the maximum payload size for PUSCH/PUCCH for the CSI report, some CSI in part 2 needs to be omitted based on a priority rule, so that the overall payload size for CSI report fit the maximum payload size that can be supported for the PUSCH/PUCCH used for CSI report. In this invention, the CSI with a higher priority value should be omitted. e.g. CSI with priority value=1 needs to be omitted compared to CSI with priority value=0.

First, a gNB may send RRC signaling to a UE to configure at least 1 ML based CSI-reportConfig. A CSI report can be considered as an AI based CSI if the codebookType in the CSI-reportConfig is set as a particular value, e.g. ‘ai-Ml’ or ‘type3’, or the reportQuantity in the CSI-reportConfig is set as a particular value, e.g. ‘ri-compressedPmi-cqi’. In addition, the gNB may also configure some non-AI based CSI reports, which may be based on a particular codebook, e.g. Type1 or Type2 codebook.

Second, the gNB may trigger at least one AI based CSI report by MAC CE or DCI. In one example, the gNB may send a MAC CE to activate semi-persistent CSI report(s). In another example, the gNB may send a DCI to trigger aperiodic CSI report(s). In another example, UE should report periodic CSI report at the uplink resource configured by RRC signaling by gNB periodically.

Third, the UE may measure the CSI-RS(s) corresponding to the triggered or configured CSI reports to derive the CSI. If the gNB configures or triggers multiple CSI reports with the total payload size exceeds the maximum payload size for the PUCCH/PUSCH used for the CSI report, UE may determine to apply a CSI omission rule to omit some CSI reports and/or some part in some CSI reports. The UE needs to determine the priority for the AI based and non-AI based CSI reports first and then if some CSI omission for AI based CSI report should be applied, UE may decide to omit some portion of the AI based CSI report. For the CSI omission for the AI based report, the following 3 embodiments for the AI based CSI report content are considered: scenario 1 corresponds to AI based CSI report may include a PMI to indicate the compressed eigen vectors for the channel in all subbands; scenario 2 corresponds to AI based CSI report may include a first PMI to indicate a selected wideband precoder and a second PMI to indicate the compressed eigen vectors for the precoded channel with the selected wideband precoder in all subbands; and scenario 3 corresponds to AI based CSI report may include a first PMI to indicate a selected wideband precoder, a second PMI to indicate the compressed eigen vectors for the precoded channel with the selected wideband precoder in even subbands, a third PMI to indicate the compressed eigen vectors for the precoded channel with the selected wideband precoder in odd subbands.

Forth, UE sends the CSI report with the remaining content for the AI based and non-AI based CSI report(s) that have been triggered or configured to report by gNB. The CSI report may be transmitted by PUCCH or PUSCH. For PUCCH, the CSI reports may be reported by long PUCCH format. The gNB may determine the remaining CSI for the CSI report based on the CSI omission rule, and then decode the CSI report accordingly.

FIG. 9B illustrates a diagram 950 of an alternative procedure for CSI reporting with regard to a CSI omission rule in accordance with other embodiments. Compared to the procedure in FIG. 9A, the difference is that for an ML-based CSI report, if CSI omission is required, UE can replace the AI based CSI with a non-AI based CSI. Then the UE can perform the CSI omission for some portion(s) of the new non-AI based CSI report. Compared to FIG. 9A, the procedure in FIG. 9B could be more flexible for UE to report more efficient CSI. However, the procedure in FIG. 9B may require higher UE complexity as UE may need to potentially measure the non-AI based CSI in addition to AI based CSI for an AI based CSI report.

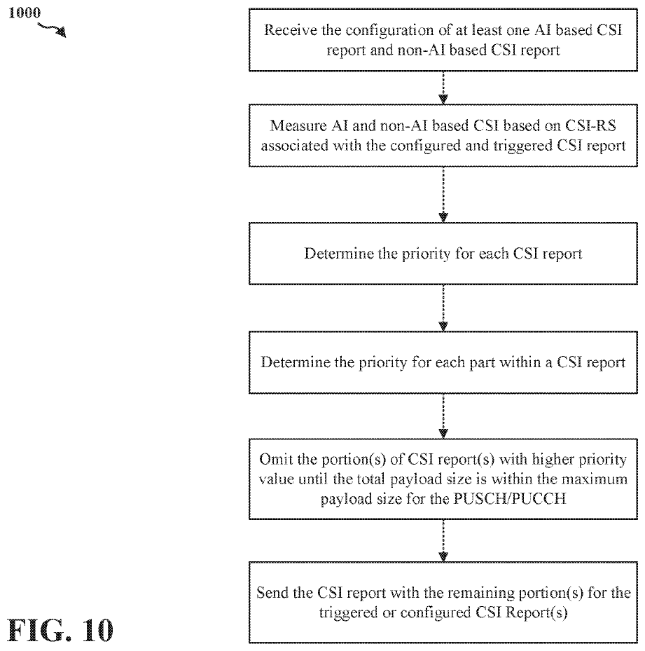

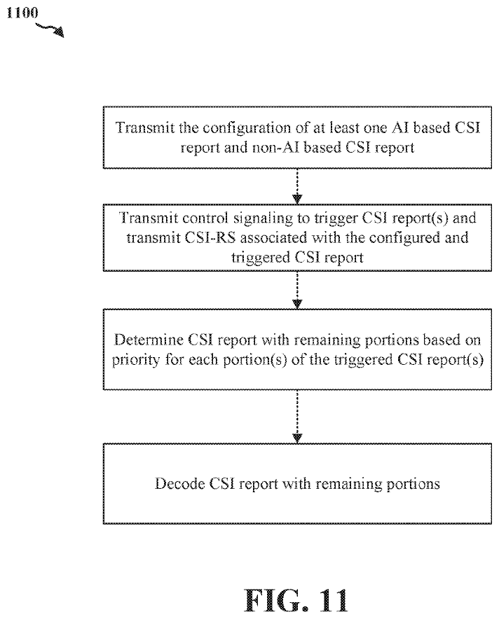

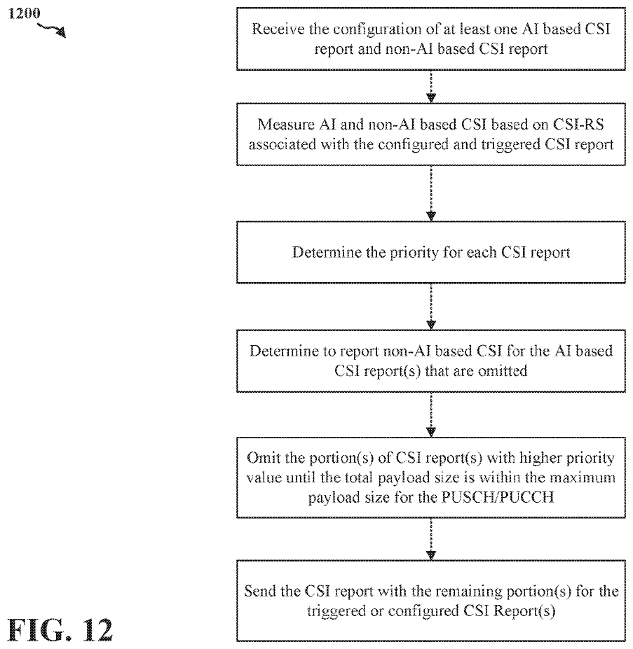

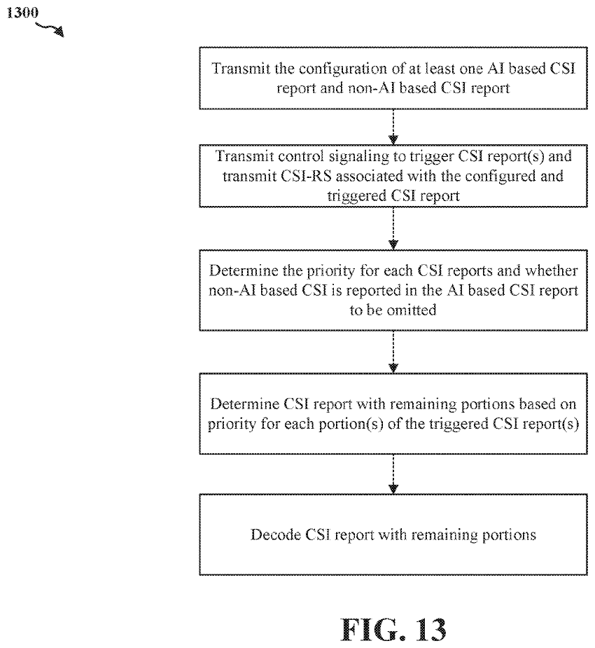

FIG. 10 is a method diagram 1000 of the UE behavior to report AI/non-AI based CSI with the CSI omission rule based on procedure in FIG. 9A. FIG. 11 is a method diagram 1100 of the gNB behavior to report AI/non-AI based CSI with the CSI omission rule based on procedure in FIG. 9A. FIG. 12 is a method diagram 1200 of the UE behavior to report AI/non-AI based CSI with the CSI omission rule based on procedure in FIG. 9B. FIG. 13 is a method diagram 1300 of the gNB behavior to report AU/non-AI based CSI with the CSI omission rule based on procedure in FIG. 9B.

Unless otherwise specified, a RRC signaling may indicate a RRC reconfiguration message from gNB to UE, or a system information block (SIB), where the SIB can be an existing SIB (e.g., SIB1) or a new SIB transmitted by gNB. In addition, the gNB may obtain the UE capability via UE capability report signaling or from a core network (e.g., Access and Mobility Management Function (AMF)).

Further in this invention, solutions described are based on 5G NR technologies. It should be understood that the solutions can be applied to other wireless technologies such as 6G. The “gNB” can be generalized as a base station or a radio access network (RAN) node.

In an embodiment, whether the AI based CSI report, i.e. CSI measured with a ML model based CSI encoder, and non-AI based CSI report, e.g. CSI measured based on a Type1/Type2 codebook, can be multiplexed and reported by a PUSCH/PUCCH may be reported by UE capability by UE, predefined or configured by higher layer signaling by gNB, e.g. RRC signaling.

In an embodiment, the priority for AI based CSI report or non-AI based report may be different. The gNB and UE may determine the priority for a CSI report by the time domain behavior for the CSI report, i.e. periodic/semi-persistent/aperiodic report, CSI-reportConfigId, serving cell ID, report quantity and whether it is measured based on AI or non-AI approach.

In examples, the priority can be calculated based on Pri_{iCSI}(y,k,c,s)=2·N_{cells}·Mₛ·y+N_{cells}·Mₛ·k+Mₛ·c+s, where an actual priority is higher if the priority value is lower (e.g., priority 0 corresponds to a higher priority than priority 1). A value of k=0 may indicate CSI reports that include L1-RSRP or L1-SINR information, a value of k=1 may indicate non-AI-based CSI reports that do not include the L1-RSRP or L1-SINR information, and a value of k=2 may indicate AI-based CSI reports that do not include the L1-RSRP or L1-SINR information. Further, y=0 indicates aperiodic CSI reports transmitted on PUSCH, y=1 indicates semi-persistent CSI reports transmitted on the PUSCH, y=2 indicates semi-persistent CSI reports transmitted on PUCCH, and y=3 indicates periodic CSI reports transmitted on PUCCH. c corresponds to the serving cell index and N_{cells} corresponds to a value of the higher layer parameter maxNorfServingCells. s corresponds to the reportConfigID and Mₛ corresponds to a value of the higher layer parameter maxNrofCSI-ReportConfigurations.

Alternatively, k=0 for CSI reports carrying L1-RSRP or L1-SINR and k=1 for AI based CSI reports not carrying L1-RSRP or L1-SINR, k=2 for non-AI based CSI reports not carrying L1-RSRP or L1-SINR. In another implementation, an AI based CSI report may be always assumed by gNB and UE to be with a higher or lower priority compared to a non-AI based CSI report.

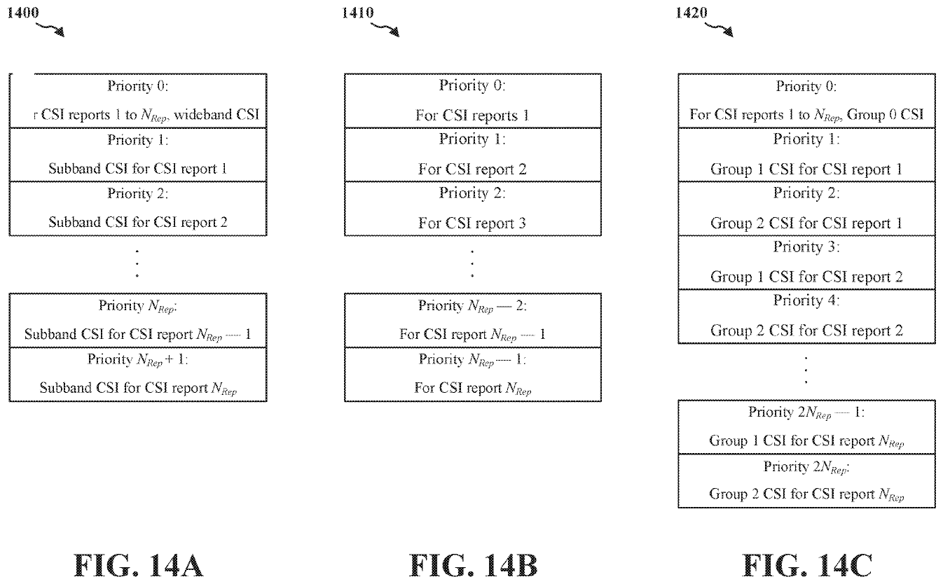

FIGS. 14A-14C illustrate tables 1400-1420 for AI-based CSI reports. In an embodiment, within an AI based CSI report, the wideband PMI and subband PMI can be assumed with different priority. This may be applicable for scenario 2 and 3 only. The priority value of wideband PMI is smaller than subband PMI, i.e. when omission is needed, subband PMI could be omitted. For scenario 2 and 3, the priority for the first PMI and the second/third PMI should be different. In one example, gNB and UE may determine the priority for N_{Rep} AI based CSI reports according to the table 1400 of FIG. 14A, where CSI report n corresponds to the CSI report with the n^{th} smallest Pri_{i,CSI}(y,k,c,s) value as the previous embodiment.

In another embodiment, gNB and UE assumes a single priority value is assigned to an AI based CSI report. This may be applicable for scenario 1, 2 and 3. Then the CSI omission priority should only be determined based on Pri_{i,CSI}(y,k,c,s) according to the table 1410 of FIG. 14B.

In another embodiment, gNB and UE assumes the AI based CSI may be divided into 3 priority groups. In one implementation, for scenario 3, the groups could be: Group 0 for wideband PMI (the first PMI), Group 1 for subband PMI for even subbands (the second PMI), and Group 2 for subband PMI for odd subbands (the third PMI). For an AI based CSI report, the ML based CSI compression may be performed twice, where the first one is for even subbands and the second one is for odd subbands.

In another implementation, for scenario 2, the groups could be: Group 0 for wideband PMI (the first PMI). Group 1 for high priority bits for subband PMI (part of the second PMI), and Group 2 for low priority bits for subband PMI (other part of the second PMI). With the high priority bits, gNB is able to recover the first Eigen vectors at a certain loss. Which bits should be high priority bits should depend on the ML models and can be predefined or configured by higher layer signaling by gNB, e.g. RRC signaling in a CSI-reportConfig. The bits in group 1 and group 2 may be generated based on a single AL/ML model or separate ML models.

In another implementation, for scenario 1, the groups could be: Group 0: high priority bits for the PMI in CSI part 2. Group 1: medium priority bits for the PMI in CSI part 2, and Group 2: low priority bits for the PMI in CSI part 2. Based on the bits with different priority, gNB may be able to recover the first Eigen vectors at a certain loss. Which bits should be high/medium/low priority bits should depend on the neural network architecture and can be predefined or configured by higher layer signaling by gNB. e.g. RRC signaling in a CSI-reportConfig. The bits in group 1/2/3 may be generated based on a single AL/ML model or separate ML models. Accordingly, the CSI omission priority could be defined according to the table 1420 of FIG. 14C.

In an embodiment, if part of the AI based CSI needs to be omitted, UE may fallback to report non-AI based CSI based on a fallback codebook, e.g. Type2 CSI codebook or eType2 CSI codebook. The fallback codebook may be configured by RRC signaling, e.g. RRC parameter in CSI-reportConfig, or predefined or reported by UE capability signaling. UE can perform CSI omission based on the rule for non-AI based CSI defined in 5.2.3 in 38.214.

In some implementation, the gNB may apply the same CSI omission rule to determine whether UE reports the AI based CSI or non-AI based CSI for an AI based CSI report. In some other implementation, for a CSI report, UE may report an additional indicator to report whether the CSI is measured based on AI or non-AI. In one implementation, such indicator may be explicitly transmitted in a CSI report, e.g. an indicator to report the codebook type used for the CSI report. In another implementation, the gNB may configure or trigger 2 PUCCH/PUSCH resources for the CSI report, where one is used for AI based report and the other is used for non-AI based report. By selecting corresponding PUCCH/PUSCH resource, UE can implicitly report whether the CSI is based on AI or non-AI. In another implementation, such indicator can be implicitly reported based on scrambling sequence for the DMRS or PUCCH/PUSCH, where one scrambling sequence is used to indicate AI based CSI report and the other is used to indicate non-AI based CSI report. By receiving such indicator, gNB can determine whether to decode the CSI as AI based CSI or non-AI based CSI.

In an embodiment, UE may use multiple ML models with different compression ratio for CSI compression, where the ML models may be configured by RRC signaling or predefined. Similarly, gNB may use multiple ML models with different compression ratio for CSI decompression. With regard to CSI omission, UE may select the ML models with highest compression ratio that can fit the overhead restriction for the PUCCH/PUSCH used for the CSI report. In some implementation, the gNB may apply the same CSI omission rule to determine the ML model for CSI decompression, where the one with highest compression ratio that can fit the overhead restriction for the PUCCH/PUSCH used for the CSI report should be selected.

In some other implementation, for a CSI report, UE may report an additional indicator to report the ML model index. The gNB and UE could maintain a list of ML models with different compression ratio. In one example, such ML models may be configured by RRC signaling from gNB to UE, or reported by UE capability, or predefined. In one implementation, such indicator may be explicitly transmitted in a CSI report, e.g. an indicator to report ML model index explicitly. In another implementation, the gNB may configure or trigger X (X is an integer above 1.) PUCCH/PUSCH resources for the CSI report, where each one is used for one ML model. By selecting corresponding PUCCH/PUSCH resource, UE can implicitly report ML model index. In another implementation, such indicator can be implicitly reported based on scrambling sequence for the DMRS or PUCCH/PUSCH, where each scrambling sequence correspond to an ML model. By receiving such indicator, gNB can determine the ML model for CSI decompression.

In an embodiment, for CSI omission for N_{Rep,1} AI based CSI report and N_{Rep,2} non-AI based CSI report, AI based CSI report may be assumed by gNB and UE with a higher or lower priority value compared to non-AI based CSI report. UE should determine to omit AI or non-AI based CSI report first in different implementations, and if further omission is still needed, UE can apply CSI omission for the remaining non-AI or AI based CSI. For AI based CSI omission, the embodiments above can be applied. For non-AI based CSI omission, the CSI omission rule defined in section 5.2.3 in 38.214 can be applied.

In another embodiment, for CSI omission for N_{Rep,1} AI based CSI report and N_{Rep,2} non-AI based CSI report, gNB and UE should determine the priority for a CSI report based on the priority for the CSI-reportConfig first, and then the priority within a CSI-reportConfig can be determined based on the priority group.

### Parallel Processing for ML-Based CSI

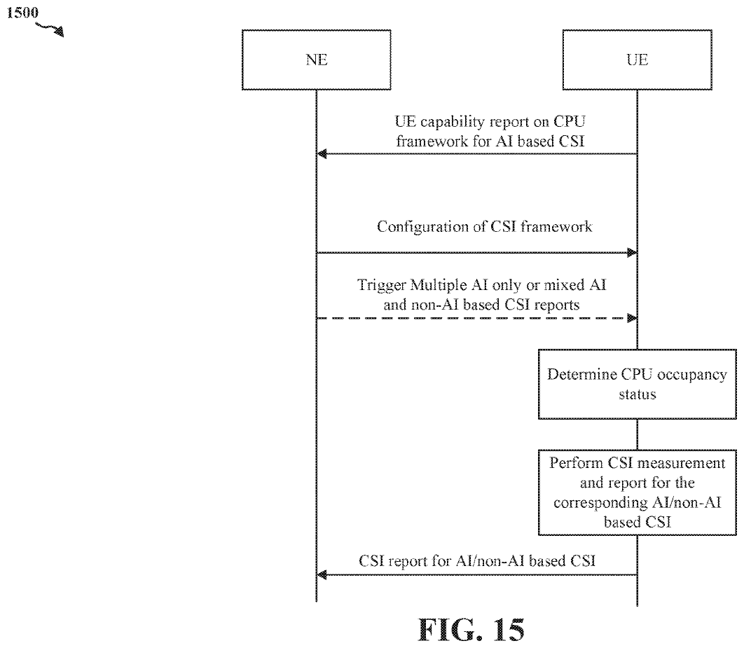

FIG. 15 is a signaling diagram 1500 illustrating a procedure for a CPU framework for AI-based CSI processing. In some embodiments, the AI based CSI may be implemented based on a different hardware compared to non-AI based CSI, e.g. neural processing unit (NPU). The NPU may be dedicated or shared with other application, e.g. non-wireless communication based application. In some other embodiments, the AI based CSI may be implemented based on the same hardware as that used for non-AI based CSI. Thus, it is necessary to introduce a second CPU framework for AI based CSI processing. In this IDF, a Type2 CPU is defined as CPU used for AI based CSI processing that cannot be shared with non-AI based CSI. Legacy CPU for non-AI based CSI processing is denoted as Type1 CPU.

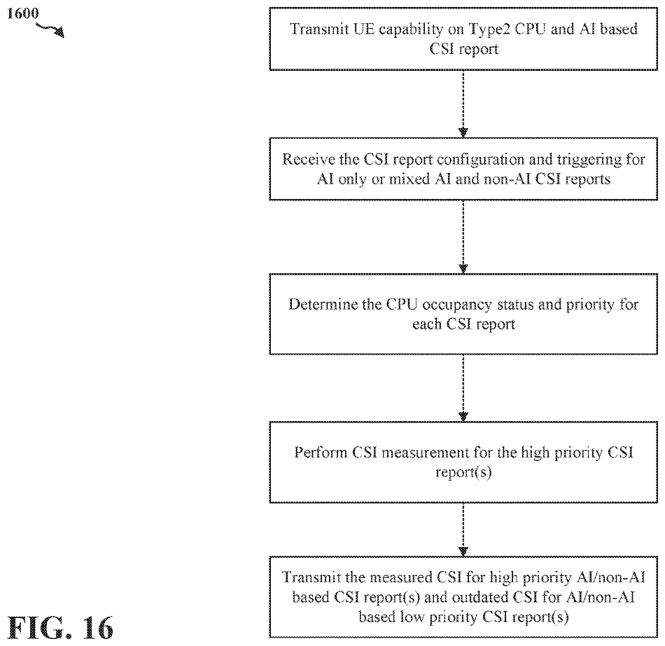

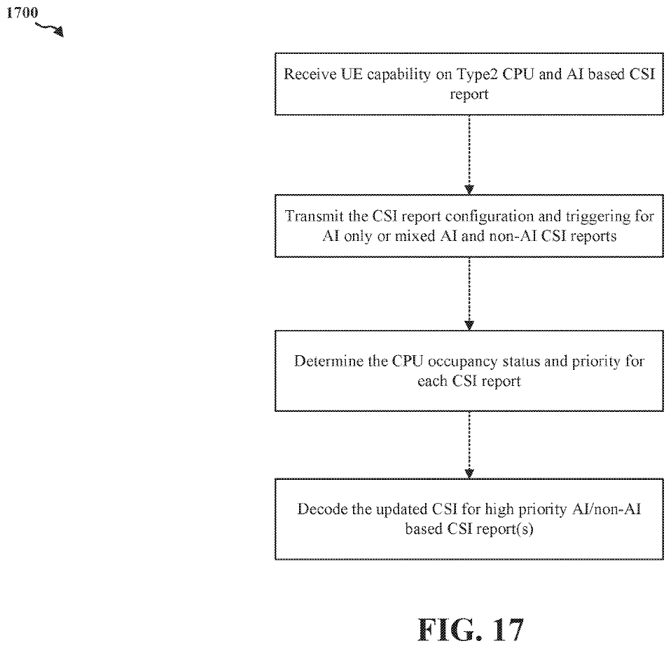

The UE can report at least one UE capabilities on whether it supports AI based CSI compression and maximum number of Type2 CPUs it supports. The gNB can provide the configuration of CSI framework for multiple CSI reports, where gNB can provide the configuration for a CSI report by RRC signaling, e.g. CSI-reportConfig. For semi-persistent and aperiodic CSI report, gNB may send a MAC CE or DCI to trigger the corresponding report, where the gNB uses MAC CE to activate the semi-persistent CSI report and DCI to trigger the aperiodic CSI report. After receiving the control signaling to trigger at least one AI based CSI report(s), UE may determine the CPU status and determine which CSI report(s) should be valid CSI report(s), e.g. CSI report(s) with latest measurement results. Then UE may send the updated CSI for high priority CSI reports and outdated CSI for low priority CSI reports if the number of Type1 or Type2 CPUs exceed the maximum number of Type1 or Type2 CPUs. FIG. 16 is a method diagram 1600 of the UE behavior for the CPU framework for AI based CSI processing. FIG. 17 is a method diagram 1700 of the gNB behavior for the CPU framework for the AI based CSI processing.

In an embodiment, during UE capability report, UE may report at least one UE capabilities on whether it supports AI based CSI processing, whether the AI based CSI processing can share the CPU for non-AI based processing and maximum number of Type2 CPUs per component carrier (CC) or per band or per band combination or per UE. The UE may report the UE capability for Type2 CPU in addition to the UE capability on maximum number of Type1 CPUs, e.g. simultaneousCSI-ReportsPerCC for number of Type1 CPUs per CC, and simultaneousCSI-ReportsAllCC for number of Type1 CPUs across all CCs. In one example, if UE reports it supports AI based CSI processing with 0 Type2 CPU, it can be assumed that the AI based CSI processing can share the CPU used for non-AI based processing. In addition, if the NPU used for AI based CSI processing can be shared with other application, UE may report an on/off duration for the Type2 CPU. When a Type2 CPU is off, it cannot be counted for AI based CSI processing. The on/off duration may be reported based on the maximum periodicity and on duration for a Type2 CPU.

In an embodiment, the gNB may configure whether an AI based CSI report should occupy Type2 CPU(s) or not. For an AI based CSI report that does not occupy Type2 CPU(s), it should occupy Type1 CPU(s). In some implementations, the gNB may provide such CPU type indication for a CSI report by RRC signaling, e.g. an RRC parameter in CSI-reportConfig. In some further implementations, the gNB may provide such CPU type indication for a CSI report by MAC CE. In one example, the gNB may provide the CPU type indication by MAC CE for semi-persistent CSI report. In another example, the gNB may provide the CPU type indication based on a separate MAC CE, where the MAC CE may provide at least one element of serving cell index, bandwidth part index, CSI-reportConfig ID(s). CPU type indication for the indicated CSI-reportConfig. In some further implementations, the gNB may provide such CPU type indication for a CSI report by DCI. In one example, for aperiodic CSI report, the gNB may indicate the CPU type by the DCI used to trigger the CSI report. A new field may be added in the DCI to indicate the CPU type. Alternatively, the gNB can configure the CPU type corresponding to a CSI trigger state, and by indicating different value of CSI request field in DCI, gNB can indicate the corresponding CPU type.

In an embodiment, if UE reports AI based CSI processing with Type2 CPU, in one implementation, a Type2 CPU is occupied based on similar rule as Type1 CPU. For example, a periodic or semi-persistent CSI report (excluding an initial semi-persistent CSI report on PUSCH after the PDCCH triggering the report) occupies Type2 CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report. An aperiodic CSI report occupies Type2 CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of 3GPP TS 38.213, for the purpose of determining the CPU occupation duration, the PDCCH candidate that ends later in time is used. An initial semi-persistent CSI report on PUSCH after the PDCCH trigger occupies Type2 CPU(s) from the first symbol after the PDCCH until the last symbol of the scheduled PUSCH carrying the report. When the PDCCH reception includes two PDCCH candidates from two respective search space sets, as described in clause 10.1 of 3GPP TS 38.213, for the purpose of determining the CPU occupation duration, the PDCCH candidate that ends later in time is used. In this implementation, the gNB and UE may consider Type2 CPU(s) as a subset of Type1 CPU(s). Thus, if a Type2 CPU is occupied, a Type1 CPU is occupied. Then the maximum number of Type2 CPU(s) reported in UE capability should be less than or equal to the maximum number of Type1 CPU(s) reported in UE capability.

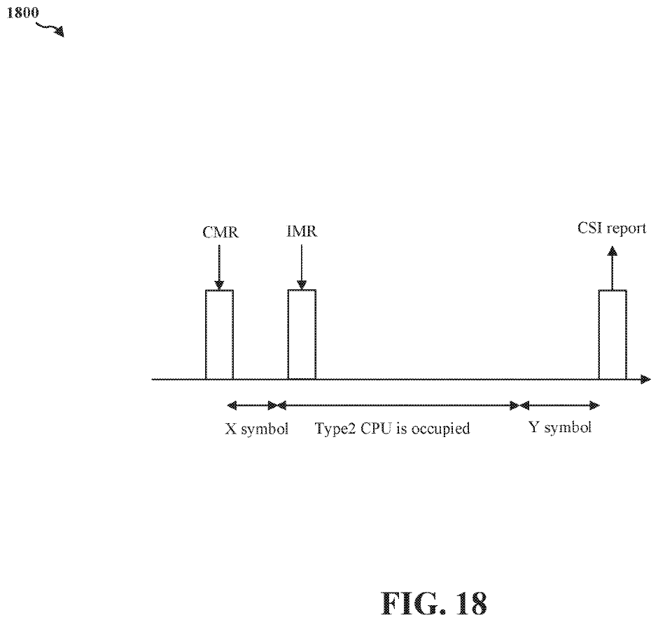

FIG. 18 illustrates a timing diagram 1800 for a Type2 CPU occupancy rule. Since the NPU would only be used after UE gets the channel, the Type2 CPU may be assumed to be occupied after X symbols after the first/last symbol of the earliest/latest channel measurement resource (CMR) or interference measurement resource (IMR), until Y symbols before the first/last symbol of PUSCH/PUCCH used for CSI report. The value of X and Y may be predefined or reported by UE capability. FIG. 18 illustrates one example for the Type2 CPU occupancy rule.

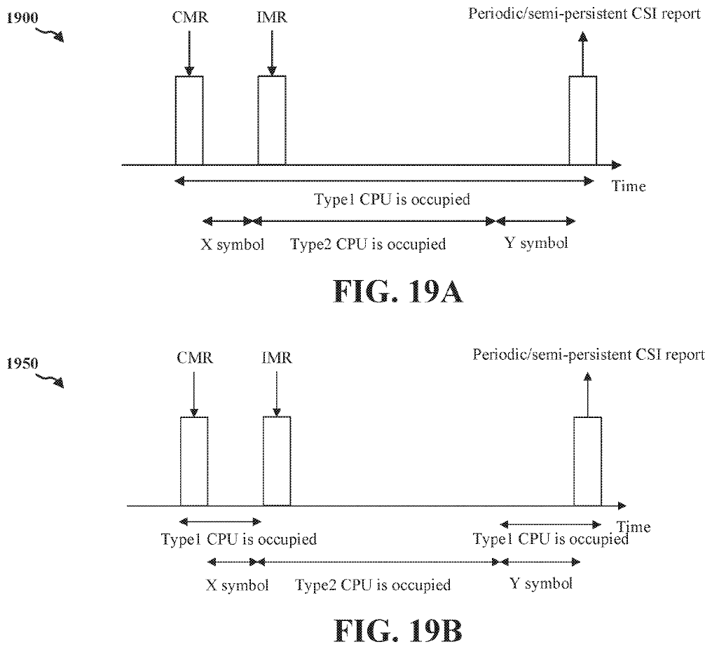

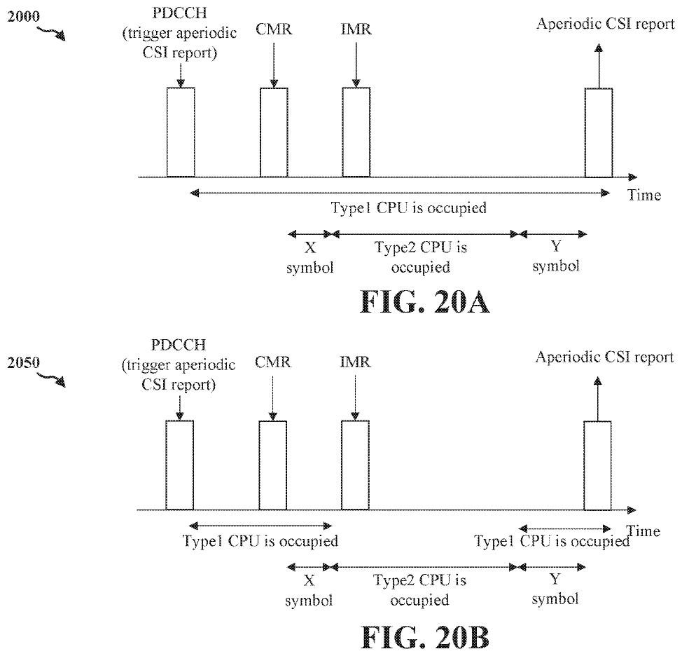

FIGS. 19A-19B illustrate example timing diagrams 1900-1950 for the CPU occupancy rule for an AI-based periodic/semi-persistent CSI report. FIGS. 20A-20B illustrate example timing diagrams 2000-2050 for the CPU occupancy rule for an AI-based aperiodic CSI report. If UE reports AI based CSI processing requires Type2 CPU, the AI based CSI processing may require Type1 CPU as well, since some other CSI processing procedure, e.g. decode of CSI-RS, RI and CQI calculation may not require neural network processing.

In one implementation, both Type1 and Type2 CPUs are occupied based on the same rule as Type1 CPU occupancy. In another implementation, gNB and UE may determine Type1 CPU is occupied based on the legacy rule and Type2 CPU is occupied after X symbols after the first/last symbol of the earliest/latest channel measurement resource (CMR) or interference measurement resource (IMR), until Y symbols before the first/last symbol of PUSCH/PUCCH used for CSI report. The value of X and Y may be predefined or reported by UE capability.

The gNB and UE may determine Type1 CPU is occupied based on the legacy rule excluding the duration when a Type2 CPU is occupied. Type2 CPU is occupied after X symbols after the first/last symbol of the earliest/latest channel measurement resource (CMR) or interference measurement resource (IMR), until Y symbols before the first/last symbol of PUSCH/PUCCH used for CSI report. The value of X and Y may be predefined or reported by UE capability.

If AI based CSI processing only requires Type2 CPU, after checking the Type2 CPU occupancy status, UE can process the N_{CPU,2} AI based CSI report with higher priority according to section 5.2.5 in 38.214, where N_{CPU,2} is the maximum number of Type2 CPUs UE reports during UE capability report. For other low priority CSI report, UE can report outdated CSI.

If AI based CSI processing only requires both Type1 and Type2 CPUs, after checking the Type1 and Type2 CPU occupancy status, UE can process the min{N_{CPU,1}−n_{CPU,1},N_{CPU,2}} AI based CSI report with higher priority, where N_{CPU,1} is the maximum number of Type1 CPUs UE reports during UE capability report and N_{CPU,1} is the number of CPUs used by other higher priority non-AI based CSI report. For other low priority CSI report(s), UE can report outdated CSI. In another embodiment, the gNB may refrain from configuring or triggering CSI reports that require more Type1 and Type2 CPUs than the maximum number of Type1 and Type2 CPUs reported by the UE from UE capability reporting.

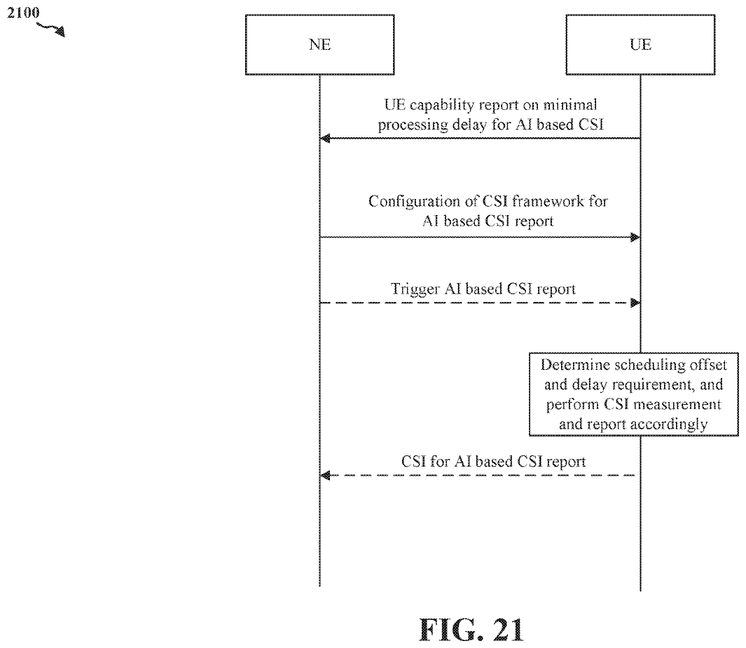

FIG. 21 illustrates a signaling diagram 2100 for a CSI report based on a minimum processing delay. The minimal processing delay for AI based CSI should depend on whether a dedicated hardware can be used. With a dedicated hardware, e.g. NPU, the neural network processing should be faster than traditional hardware based approach. In addition, the minimal processing delay also depends on the neural network architecture. If the gNB scheduling leads to a smaller scheduling offset than the minimal processing delay, UE may decide to report an outdated CSI or ignore the DCI if no HARQ-ACK or data is to be transmitted on the PUSCH triggered by the DCI.

The UE may report the capability on minimal processing delay for AI based CSI report. The gNB can provide the configuration of CSI framework for multiple CSI reports, where gNB can provide the configuration for a CSI report by RRC signaling, e.g. CSI-reportConfig. For semi-persistent and aperiodic CSI report, gNB may send a MAC CE or DCI to trigger the corresponding report, where MAC CE is used to activate the semi-persistent CSI report and DCI is used to trigger the aperiodic CSI report. UE can determine the scheduling offset for the CSI report so that it can determine whether to perform the AI based CSI report or not. If the scheduling offset meets the minimal processing delay for AI based CSI report, UE may report the AI based CSI.

The UE may report the minimal processing delay Z and Z′ for AI based CSI report, where Z and Z′ may indicate when the CSI request field on a DCI triggers an AI based CSI report(s) on PUSCH, such that the UE shall provide a valid AI based CSI report for the n-th triggered report, if the first uplink symbol to carry the corresponding AI based CSI report(s) including the effect of the timing advance, starts no earlier than at symbol Z, and if the first uplink symbol to carry the n-th AI based CSI report including the effect of the timing advance, starts no earlier than at symbol Z′.

The minimal processing delay Z and Z′ may be determined by gNB and UE based on the whether UE would take Type2 CPU or not for AI based CSI report. In one example, two sets of Z and Z′ may be predefined, where the first one may be used for UE that does not take Type2 CPU and the second one may be used for UE that takes Type2 CPU for a AI based CSI report.

As the minimal processing delay depends on the ML models, the UE may report the supported Z and Z′ for each ML model it supports. UE may report more than 1 ML models that it supports. The gNB may indicate the ML model to be used for AI based CSI by higher layer signaling, e.g. RRC signaling in CSI-reportConfig. Then the corresponding minimal processing delay should apply for the AI based CSI report.

The UE may not be able to perform parallel processing for AI based CSI report due to limitation of dedicated hardware. Then the minimal processing delay may be determined based on the number of AI based CSI reports for CSI report at the same time. The minimal processing delay Z and Z′ for one AI based CSI report may be predefined or reported by UE capability by UE. For N AI based CSI report, the minimal processing delay could be uNZ and uNZ′, where u may be predefined, configured by higher layer signaling by gNB. e.g. RRC signaling in CSI-reportConfig, or reported by UE capability with the range within (0, 1]. UE may also report whether it supports parallel processing or not as a second UE capability.

For triggered AI based CSI report(s), if the scheduling offset does not meet the minimal Z or Z′ requirement, UE may ignore the DCI if no HARQ-ACK or data is transmitted on the PUSCH scheduled by the DCI. For triggered AI based CSI report(s), if the scheduling offset does not meet the minimal Z or Z′ requirement, UE may report outdated CSI for all the triggered CSI report(s). For triggered AI based CSI report(s), if the scheduling offset does not meet the minimal Z or Z′ requirement, UE may report outdated CSI for the triggered CSI report that does not meet the minimal Z or Z′ requirement. The gNB may refrain from configuring or triggering AI based CSI reports with smaller scheduling offset than the minimal processing delay for the AI based CSI report.

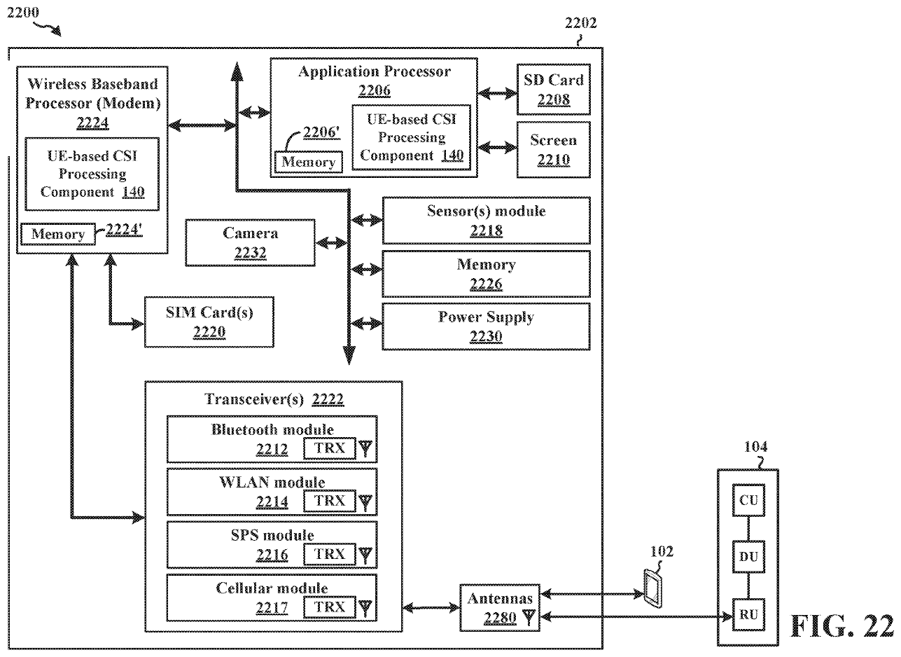

FIG. 22 is a diagram 2200 illustrating an example of a hardware implementation for a UE apparatus 2202. The apparatus 2202 may be the UE 102, a component of the UE 102, or may implement UE functionality. In some aspects, the apparatus 2202 may include a wireless baseband processor 2224 (also referred to as a modem) coupled to one or more transceivers 2222 (e.g., wireless RF transceiver). The wireless baseband processor 2224 may include on-chip memory 2224′. In some aspects, the apparatus 2202 may further include one or more subscriber identity modules (SIM) cards 2220 and an application processor 2206 coupled to a secure digital (SD) card 2208 and a screen 2210. The application processor 2206 may include on-chip memory 2206′.

The apparatus 2202 may further include a Bluetooth module 2212, a WLAN module 2214, an SPS module 2216 (e.g., GNSS module), and a cellular module 2217 within the one or more transceivers 2222. The Bluetooth module 2212, the WLAN module 2214, the SPS module 2216, and the cellular module 2217 may include an on-chip transceiver (TRX)(or in some cases, just a receiver (RX)). The Bluetooth module 2212, the WLAN module 2214, the SPS module 2216, and the cellular module 2217 may include their own dedicated antennas and/or utilize the antennas 2280 for communication. The apparatus 2202 may further include one or more sensor modules 2218 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 2226, a power supply 2230, and/or a camera 2232.

The wireless baseband processor 2224 communicates through the transceiver(s) 2222 via one or more antennas 2280 with another UE 102s and/or with an RU associated with a base station 104. The wireless baseband processor 2224 and the application processor 2206 may each include a computer-readable medium/memory 2224′, 2206′, respectively. The additional modules of memory 2226 may also be considered a computer-readable medium/memory. Each computer-readable medium/memory 2224′, 2206′, 2226 may be non-transitory. The wireless baseband processor 2224 and the application processor 2206 are each responsible for general processing, including the execution of software stored on the computer-readable medium/memory. The software, when executed by the wireless baseband processor 2224/application processor 2206, causes the wireless baseband processor 2224/application processor 2206 to perform the various functions described. The computer-readable medium/memory may also be used for storing data that is manipulated by the wireless baseband processor 2224/application processor 2206 when executing software. The wireless baseband processor 2224/application processor 2206 may be a component of the UE 102. The apparatus 2202 may be a processor chip (modem and/or application) and include just the wireless baseband processor 2224 and/or the application processor 2206, and in another configuration, the apparatus 2202 may be the entire UE 102 and include the additional modules of the apparatus 2202.

As discussed, the UE-based CSI processing component 140 is configured to receive a CSI-RS from a network entity. The UE-based CSI processing component 140 is further configured to select a wideband precoder for compression of a CSI report based on a measurement of the CSI-RS. Selection of the wideband precoder is based on a whole bandwidth for receiving the CSI-RS. The UE-based CSI processing component 140 is further configured to compress, with the selected wideband precoder, the CSI report using one or more subband eigenvectors for one or more precoded estimated subband channels. The UE-based CSI processing component 140 is further configured to transmit, to the network entity, a first PMI that indicates the wideband precoder and a second PMI that indicates the one or more subband eigenvectors.

In further examples, the UE-based CSI processing component 140 is configured to receive one or more CSI-RSs from a network entity for transmission of one or more CSI reports to the network entity. At least one CSI report of the one or more CSI reports is based on an ML model. The UE-based CSI processing component 140 is further configured to omit at least a portion of the at least one CSI report that is based on the ML model when a total payload size of the one or more CSI reports exceeds a threshold. The UE-based CSI processing component 140 is further configured to transmit, to the network entity, the one or more CSI reports with the at least the portion of the at least one CSI report omitted from the transmission.

In still further examples, the UE-based CSI processing component 140 is configured to receive, from a network entity, a configuration for a CSI report processing procedure. The configuration is for at least one of: (a) processing a plurality of CSI reports using an ML model or (b) processing a first set of CSI reports, and not a second set of CSI reports, using the ML model. The UE-based CSI processing component 140 is further configured to receive, from the network entity, a plurality of CSI-RSs. Measurements of the plurality of CSI-RSs are based on a UE capability for the CSI report processing procedure. The UE-based CSI processing component 140 is further configured to communicate CSI reports to the network entity based on the UE capability for the CSI report processing procedure.

The UE-based CSI processing component 140 may be within the wireless baseband processor 2224, the application processor 2206, or both the wireless baseband processor 2224 and the application processor 2206. The UE-based CSI processing component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 2202 may include a variety of components configured for various functions. In one configuration, the apparatus 2202, and in particular the wireless baseband processor 2224 and/or the application processor 2206, includes means for receiving a CSI-RS from a network entity; means for selecting a wideband precoder for compression of a CSI report based on a measurement of the CSI-RS, where selection of the wideband precoder is based on a whole bandwidth for receiving the CSI-RS; means for compressing, with the selected wideband precoder, the CSI report using one or more subband eigenvectors for one or more precoded subband channels; and means for transmitting/sending, to the network entity, a first PMI that indicates the wideband precoder and a second PMI that indicates the one or more subband eigenvectors. The apparatus 2202 further includes means for receiving one or more channel state information-reference signals (CSI-RSs) from a network entity for transmission of one or more CSI reports to the network entity, at least one CSI report of the one or more CSI reports based on an ML model; means for omitting at least a portion of the at least one CSI report that is based on the ML model when a total payload size of the one or more CSI reports exceeds a threshold; and means for transmitting, to the network entity, the one or more CSI reports with the at least the portion of the at least one CSI report omitted from the transmission. The apparatus 2202 further includes means for receiving, from a network entity, a configuration for a CSI report processing procedure, where the configuration is for at least one of: (a) processing a plurality of CSI reports using an ML model or (b) processing a first set of CSI reports, and not a second set of CSI reports using the ML model; means for receiving, from the network entity, a plurality of CSI-RSs, where measurements of the plurality of CSI-RSs are based on a UE capability for the CSI report processing procedure; and means for communicating CSI reports to the network entity based on the UE capability for the CSI report processing procedure. The means may be the UE-based CSI processing component 140 of the apparatus 2202 configured to perform the functions recited by the means.

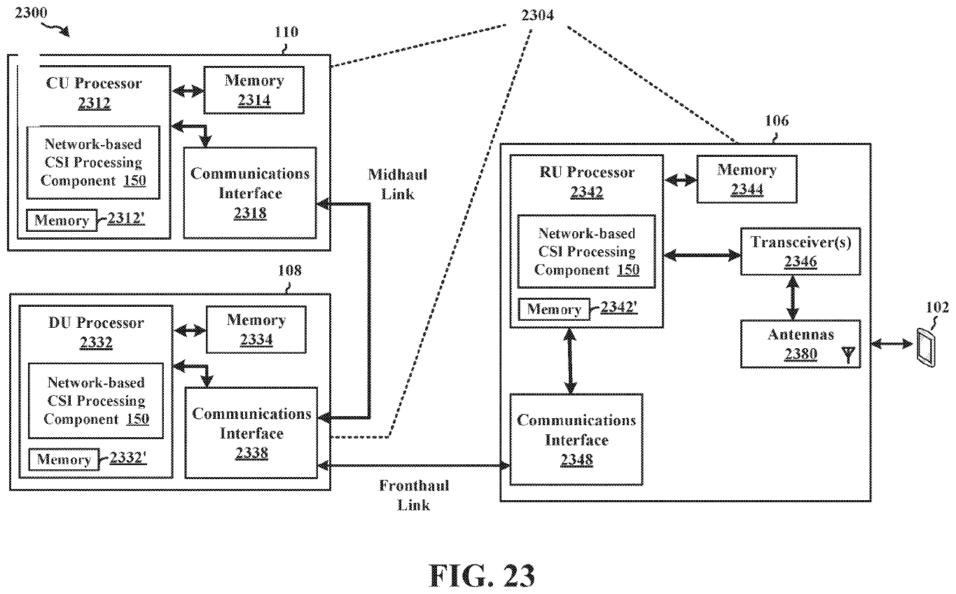

FIG. 23 is a diagram 2300 illustrating an example of a hardware implementation for one or more network entities 2304. The one or more network entities 2304 may be a base station, a component of the base station, or may implement base station functionality. The one or more network entities 2304 may include at least one of a CU 110, a DU 108, or an RU 106. For example, depending on the layer functionality handled by the network-based CSI processing component 150, the one or more network entities 2304 may include the CU 110; both the CU 110 and the DU 108; each of the CU 110, the DU 108, and the RU 106; the DU 108; both the DU 108 and the RU 106; or the RU 106.

The CU 110 may include a CU processor 2312. The CU processor 2312 may include on-chip memory 2312′. In some aspects, the CU 110 may further include additional memory modules 2314 and a communications interface 2318. The CU 110 communicates with the DU 108 through a midhaul link, such as an F1 interface. The DU 108 may include a DU processor 2332. The DU processor 2332 may include on-chip memory 2332′. In some aspects, the DU 108 may further include additional memory modules 2334 and a communications interface 2338. The DU 108 communicates with the RU 106 through a fronthaul link. The RU 106 may include an RU processor 2342. The RU processor 2342 may include on-chip memory 2342′. In some aspects, the RU 106 may further include additional memory modules 2344, one or more transceivers 2346, antennas 2380, and a communications interface 2348. The RU 106 communicates wirelessly with the UE 102.

The on-chip memory 2312′, 2332′, 2342′ and the additional memory modules 2314, 2334, 2344 may each be considered a computer-readable medium/memory. Each computer-readable medium/memory may be non-transitory. Each of the processors 2312, 2332, 2342 is responsible for general processing, including the execution of software stored on the computer-readable medium/memory. The software, when executed by the corresponding processor(s) causes the processor(s) to perform the various described functions. The computer-readable medium/memory may also be used for storing data that is manipulated by the processor(s) when executing software.

As discussed, the network-based CSI processing component 150 is configured to transmit a CSI-RS to a UE for selection of a wideband precoder that compresses a CSI report based on a measurement of the CSI-RS. The selection of the wideband precoder is based on a whole bandwidth for transmitting the CSI-RS. The network-based CSI processing component 150 is further configured to receive, from the UE, the CSI report compressed with the selected wideband precoder using one or more subband eigenvectors for one or more precoded subband channels, a first PMI that indicates the wideband precoder, and a second PMI that indicates the one or more subband eigenvectors. The network-based CSI processing component 150 is further configured to decompress the CSI report using the first PMI and the second PMI as inputs to an ML model that outputs the decompressed CSI report.

In further examples, the network-based CSI processing component 150 is configured to transmit one or more CSI-RSs to a UE for one or more CSI reports. At least one CSI report of the one or more CSI reports is based on an ML model. The network-based CSI processing component 150 is further configured to receive, from the UE, the one or more CSI reports with at least a portion of the at least one CSI report based on the ML model being omitted from the reception of the one or more CSI reports when a total payload size of the one or more CSI reports exceeds a threshold.

In still further examples, the network-based CSI processing component 150 is configured to transmit, to a UE, a configuration for a CSI report processing procedure. The configuration is for at least one of: (a) processing a plurality of CSI reports using an ML model or (b) processing a first set of CSI reports, and not a second set of CSI reports, using the ML model. The network-based CSI processing component 150 is further configured to transmit, to the UE, a plurality of CSI-RSs. Measurements of the plurality of CSI-RSs are based on a UE capability for the CSI report processing procedure. The network-based CSI processing component 150 is further configured to communicate CSI reports to the UE based on the UE capability for the CSI report processing procedure.

The network-based CSI processing component 150 may be within one or more processors of one or more of the CU 110, DU 108, and the RU 106. The network-based CSI processing component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 2304 may include a variety of components configured for various functions. In one configuration, the one or more network entities 2304 include means for transmitting a CSI-RS to a UE for selection of a wideband precoder that compresses a CSI report based on a measurement of the CSI-RS, the selection of the wideband precoder based on a whole bandwidth for the transmitting the CSI-RS; means for receiving, from the UE, the CSI report compressed with the selected wideband precoder using one or more subband eigenvectors for one or more precoded subband channels, a first PMI that indicates the wideband precoder, and a second PMI that indicates the one or more subband eigenvectors; and means for decompressing the CSI report using the first PMI and the second PMI as inputs to an ML model that outputs the decompressed CSI report. The one or more network entities 2304 further includes include means for transmitting one or more CSI-RSs to a UE for one or more CSI reports, at least one CSI report of the one or more CSI reports based on an ML model, and means for receiving, from the UE, the one or more CSI reports with at least a portion of the at least one CSI report based on the ML model being omitted from the reception of the one or more CSI reports when a total payload size of the one or more CSI reports exceeds a threshold. The one or more network entities 2304 further includes include means for transmitting, to a UE, a configuration for a CSI report processing procedure, wherein the configuration is for at least one of: (a) processing a plurality of CSI reports using an ML model or (b) processing a first set of CSI reports, and not a second set of CSI reports, using the ML model; means for transmitting, to the UE, a plurality of CSI-RSs, wherein measurements of the plurality of CSI-RSs are based on a UE capability for the CSI report processing procedure; and means for communicating CSI reports to the UE based on the UE capability for the CSI report processing procedure. The means may be the network-based CSI processing component 150 of the one or more network entities 2304 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A. B, or C” include any combination of A. B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving CSI-RS from a base station; selecting a wideband precoder W₁ based on the CSI-RS; compressing subband eigen vectors, based on the CSI-RS and the wideband precoder W₁; and sending to the base station a first PMI indicating the wideband precoder W₁ and a second PMI, indicating compressed subband eigen vectors.

Example 2 may be combined with example 1 and further includes receiving a RRC message, from the base station, configuring a wideband precoder codebook and the number of beams for the wideband precoder W₁.

Example 3 may be combined with any of examples 1-2 and includes that the RRC message is a RRC reconfiguration message.

Example 4 may be combined with any of examples 1-3 and further includes determining the subband eigen vectors, before the compressing, as the first v columns of eigen vector(s) of

$$\frac{1}{N} {\sum }_{k ∈ S} {\hat{H}}_{k} {W}_{1} ,$$

where N indicates the number of CSI-RS resource elements for subband S; Ĥₖ is the estimated channel based on CSI-RS at resource element k.

Example 4 may be combined with any of examples 1-3 and further includes compressing the subband eigen vectors, based on an AI/ML model.

Example 5 may be combined with any of examples 1-4 and further includes receiving, from the base station, a RRC message for configuring the AI/ML model.

Example 6 may be combined with any of examples 1-5 and includes that the AI/ML model is a predefined AI/ML model or predetermined by the UE.

Example 7 may be combined with any of examples 1-6 and includes that the sending the first PMI and the second PMI further includes: generating a PUCCH transmission using a short PUCCH format and including the first PMI and the second PMI in a single part of the short PUCCH format; and transmitting the PUCCH transmission to the base station.

Example 8 may be combined with any of examples 1-7 and includes that the sending the first PMI and the second PMI further includes generating a PUCCH transmission using a long PUCCH format and including the first PMI and the second PMI in a CSI part 2 of the long PUCCH format; and transmitting the PUCCH transmission to the base station.

Example 9 may be combined with any of examples 1-8 and includes that the sending the first PMI and the second PMI further includes generating a PUCCH transmission using a long PUCCH format and including the first PMI in a CSI part 1 and the second PMI in a CSI part 2 of the long PUCCH format, and transmitting the PUCCH transmission to the base station.

Example 10 may be combined with any of examples 1-9 and includes that the sending the first PMI and the second PMI further includes: generating a PUSCH transmission and including the first PMI and the second PMI in a CSI part 2 of the PUSCH transmission; and transmitting the PUSCH transmission to the base station.

Example 11 may be combined with any of examples 1-10 and includes that the sending the first PMI and the second PMI further includes: generating a PUSCH transmission and including the first PMI in a CSI part 1 and the second PMI in a CSI part 2 of the PUSCH transmission; and transmitting the PUSCH transmission to the base station.

Example 12 is a method of wireless communication at a base station, including: transmitting CSI-RS to a UE; transmitting, to the UE, a first RRC message configuring a wideband precoder codebook and the number of beams for a wideband precoder W₁; receiving from the UE a first precoder matrix indicator (PMI) indicating the wideband precoder W₁ and a second PMI, indicating compressed subband eigen vectors; decompressing the compressed subband eigen vectors to obtain uncompressed subband eigen vectors; and transmitting PDSCH signals using a precoder based on the uncompressed subband eigen vectors.

Example 13 may be combined with example 12 and includes that the precoder is derived based on the uncompressed subband eigen vectors and wideband PMI.

Example 14 may be combined with any of examples 12-13 and further includes decompressing, based on an ML model, the compressed subband eigen vectors to obtain uncompressed subband eigen vectors, based on an ML model.

Example 15 may be combined with any of examples 12-14 and further includes transmitting a second RRC message configuring the AI/ML model to the UE.

Example 16 may be combined with any of examples 12-15 and includes that the AI/ML model is a predefined AI/ML model or is predetermined by the base station.

Example 17 may be combined with any of examples 12-16 and includes that the receiving the first PMI and the second PMI further includes: receiving a PUCCH transmission including the first PMI and the second PMI in accordance with a short PUCCH format.

Example 18 may be combined with any of examples 12-17 and includes that the receiving the first PMI and the second PMI further includes: receiving a PUCCH transmission including the first PMI and the second PMI in CSI part 2 in accordance with a long PUCCH format.

Example 19 may be combined with any of examples 12-18 and includes that the receiving the first PMI and the second PMI further includes receiving a PUCCH transmission including the first PMI in CSI part 1 and the second PMI in CSI part 2 in accordance with a long PUCCH format.

Example 20 may be combined with any of examples 12-19 and includes that the receiving the first PMI and the second PMI further includes receive a physical uplink shared channel (PUSCH) transmission including the first PMI and the second PMI in CSI part 2.

Example 21 may be combined with any of examples 12-20 and includes that the receiving the first PMI and the second PMI further includes: receiving a PUSCH transmission including the first PMI in CSI part 1 and the second PMI in CSI part 2.

Example 22 is a method of wireless communication at a UE, including: receiving one or more CSI-RS from a base station; obtaining an uplink resource to be used for CSI reporting; obtaining at least one ML-processed CSI report based on at least one first CSI-RS of the one or more CSI-RSs; obtaining at least one non-AI-based CSI report based on at least one second CSI-RS of one or more CSI-RSs; identifying that the uplink resource for CSI part 2 is insufficient to carry the at least one AI-based CSI report and at least one non-AI-based CSI report; determining priorities for the at least one AI-based CSI report and at least one non-AI-based CSI report; omitting, based on the priorities, one or some of the at least one AI-based CSI report and/or the at least one non-AI-based CSI report from CSI part 2; and transmitting the remaining CSI report(s) on the uplink resource to the base station in CSI part 2.

Example 23 may be combined with example 22 and includes that the first at least one first CSI-RS and at least one second CSI-RS can include the same CSI-RS(s) and/or different CSI-RS(s).

Example 24 may be combined with any of examples 22-23 and includes that the uplink resource is a resource for a PUSCH transmission.

Example 25 may be combined with any of examples 22-24 and includes that the uplink resource is a resource for a PUCCH transmission.

Example 26 may be combined with any of examples 22-24 and further includes receiving, from the base station, at least one first CSI report configuration configuring AI-based CSI reporting; and receiving, from the base station, at least one second CSI report configuration configuring non-AI-based CSI reporting; and includes the UE generating the at least one AI-based CSI report based on the at least one first CSI report configuration and a received at least one first CSI-RS, and generating the at least one non-AI-based CSI report based on the at least one second CSI report configuration and a received at least one second CSI-RS.

Example 27 may be combined with any of examples 22-26 and includes that the determining priorities for the at least one AI-based CSI report and at least one non-AI-based CSI report further includes: determining a priority for each CSI report of the at least one AI-based CSI report and the at least one non-AI-based CSI report, based on time domain reporting behavior. CSI-reportConfigId, serving cell ID, report quantity and/or whether the CSI report is AI-based or non-AI based CSI report.

Example 28 may be combined with any of examples 22-27 and includes that the determining and omitting steps further includes: determining the at least one non-AI-based CSI report has lower priority/priorities than the at least one AI-based CSI report; and omitting one, some or all of the at least one non-AI-based CSI report based on the low priority/priorities.

Example 29 may be combined with any of examples 22-28 and includes that the determining and omitting steps further includes determining the at least one AI-based CSI report has lower priority/priorities than the at least one non-AI-based CSI report; and omit one, some or all of the at least one AI based CSI report based on the low priority/priorities.

Example 30 is a method of wireless communication at a UE, including receiving a CSI-RS from a base station; obtaining an uplink resource to be used for CSI reporting; determining a first PMI, a second PMI, and a third PMI for an AI-based CSI report, based on the CSI-RS, which indicate the wideband precoder, compressed eigen vectors for channels with the selected wideband precoder in even subbands, and compressed eigen vectors for channels with the selected wideband precoder in odd subbands, respectively; identifying that the uplink resource for CSI part 2 is insufficient to carry the first PMI, the second PMI, and the third PMI; determining priorities for the first PMI, the second PMI, and the third PMI; omitting, from CSI part 2, one or some of the first PMI, second PMI, and third PMI, based on the priorities CSI part 2; and transmitting, to the base station after the omission, the other of the first PMI, second PMI, and third PMI on the uplink resource for CSI part 2.

Example 31 may be combined with example 30 and includes that the uplink resource is a resource for a PUSCH transmission.

Example 32 may be combined with any of examples 30-31 and includes that the uplink resource is a resource for a PUCCH transmission.

Example 33 may be combined with any of examples 30-32 and further includes receiving a CSI report configuration configuring AI-based CSI report from the base station; and includes that the UE receives the CSI-RS, based on the CSI report configuration.

Example 34 may be combined with any of examples 30-33 and includes that the determining priorities for the PMIs and the omitting step further including: determining the second and the third PMIs have a lower priority than the first PMI; and omitting the second and/or the third PMI based on the low priority.

Example 35 may be combined with any of examples 30-34 and includes that the determining priorities for the PMIs and the omitting step further includes: determining the first PMI has a lower priority than the second and the third PMI; and omitting the first PMI based on the low priority.

Example 36 may be combined with any of examples 30-35 and includes that the second PMI has a higher priority than the third PMI.

Example 37 may be combined with any of examples 30-36 and includes that the second PMI has a lower priority than the third PMI.

Example 38 may be combined with any of examples 30-37 and includes that the uplink resource is a resource for a PUSCH transmission.

Example 39 may be combined with any of examples 30-38 and includes that the uplink resource is a resource for a PUCCH transmission.

[start] Example 40 is a method of wireless communication at a UE, including: receiving a channel state information reference signal (CSI-RS) from a base station; obtaining an uplink resource to be used for channel state information (CSI) reporting; determining a first PMI and a second PMI for artificial intelligence (AI)-based CSI report, based on the CSI-RS, which indicate the wideband precoder, and compressed eigen vectors for channels with the selected wideband precoder in all subbands, respectively; identifying that the uplink resource for CSI part 2 is insufficient to carry the first PMI, the second PMI; determining priorities for the first and the second PMIs; omitting one of the first and second PMIs in CSI part 2, based on the priorities; and transmitting the other of the first and second PMIs on the uplink resource for CSI part 2 to the base station after the omission.

Example 41 may be combined with example 40 and includes that the determining priorities for the PMIs and the omitting step further includes: determining the first PMI has a higher priority than the second PMI; and omitting part or all the second PMI based on the low priority.

Example 42 may be combined with any of examples 40-41 and includes that the determining priorities for the PMIs and the omitting step further includes determining the second PMI has a higher priority than the first PMI; and omitting the first PMI based on the low priority.

Example 43 may be combined with any of examples 40-42 and includes that for the second PMI, some bits may have a higher priority than the other bits PMI, and the lower priority bits can be omitted.

Example 44 may be combined with any of examples 40-43 and includes that the higher priority bits and lower priority bits may be determined based on a single AL/ML model.

Example 45 may be combined with any of examples 40-44 and includes that the higher priority bits and lower priority bits may be determined based on different AL/ML models.

Example 46 may be combined with any of examples 40-45 and includes that the higher priority bits may be predefined or configured by RRC signaling.

Example 47 may be combined with any of examples 40-45 and includes that the uplink resource is a resource for a PUSCH transmission.

Example 48 may be combined with any of examples 40-46 and includes that the uplink resource is a resource for a PUCCH transmission.

Example 49 is a method of wireless communication at a UE, including: receiving one or more CSI-RS from a base station; obtaining an uplink resource to be used for CSI reporting; determining at least one first feedback element for AI-based CSI report, based on at least one first CSI-RS of the one or more CSI-RSs: determining at least one second feedback element for non-AI-based CSI report, at least one second CSI-RS of the one or more CSI-RSs; identifying that the uplink resource for CSI part 2 is insufficient to carry the at least one first feedback element and at least one second feedback element; determining priorities for the at least one first feedback element and at least one second; omitting one or some of the at least one first feedback element and/or the at least one second feedback element in CSI part 2, based on the priorities; and transmitting the remaining feedback element(s) on the uplink resource for CSI part 2 after the omission.

Example 50 may be combined with example 49 and includes that the first at least one first CSI-RS and at least one second CSI-RS can include the same CSI-RS(s) and/or different CSI-RS(s).

Example 51 may be combined with any of examples 49-50 and includes that the uplink resource is a resource for a PUSCH transmission.

Example 52 may be combined with any of examples 49-51 and includes that the uplink resource is a resource for a PUCCH transmission.

Example 53 may be combined with any of examples 49-52 and further includes: receiving at least one first CSI report configuration configuring AI-based CSI reporting from the base station; and receiving at least one second CSI report configuration configuring non-AI-based CSI reporting from the base station; and includes that the UE obtains the at least one first feedback element and/or receive the at least one first CSI-RS, based on the at least one first CSI report configuration, and obtains the at least one second feedback element and/or receive the at least one second CSI-RS, based on the at least one second CSI report configuration.

Example 54 may be combined with any of examples 49-53 and includes that the determining and omitting steps further includes: determining the at least one second feedback element has lower priority/priorities than the at least one first feedback element; and omitting one, some or all of the at least one non-AI-based CSI report based on the low priority/priorities.

Example 55 may be combined with any of examples 49-54 and includes that the determining and omitting steps further includes: determining the at least one first feedback element has lower priority/priorities than the at least one second feedback element; and omitting one, some or all of the at least one AI based CSI report based on the low priority/priorities.

Example 56 is a method of wireless communication at a UE, including: receiving a CSI-RS from a base station; obtaining an uplink resource to be used for CSI reporting; determining a set of PMIs for AI-based CSI report based on at least one AI/ML model(s) and the CSI-RS, which indicate the compressed eigen vectors for channels with the selected wideband precoder in all subbands; identifying that the uplink resource for CSI part 2 is insufficient to carry some of the set of PMIs; and transmitting a PMI of the set of PMIs with maximum bitwidth that can fit maximum payload size for the uplink resource on the uplink resource for CSI part 2 to the base station.

Example 57 may be combined with example 45 and includes that the AI/ML models may be predefined or configured by RRC signaling.

Example 58 may be combined with any of examples 56-57 and includes that the uplink resource is a resource for a PUSCH transmission.

Example 59 may be combined with any of examples 56-58 and includes that the uplink resource is a resource for a PUCCH transmission.

Example 60 is a method of wireless communication at a UE, including: receiving a CSI-RS from a base station; obtaining an uplink resource to be used for CSI reporting; determining a first PMI for AI-based CSI report based on the CSI-RS, which indicate the compressed eigen vectors for channels in all subbands; determining a second PMI for non-artificial intelligence (non-AI)-based CSI report based on the CSI-RS and a codebook; identifying that the uplink resource for CSI part 2 is insufficient to carry the first PMI; and transmitting the second PMI with CSI omission of the first PMI on the uplink resource for CSI part 2 to the base station.

Example 61 may be combined with example 60 and includes that the codebook may be predefined or configured by RRC signaling.

Example 62 may be combined with any of examples 60-61 and includes that the uplink resource is a resource for a PUSCH transmission.

Example 63 may be combined with any of examples 60-62 and includes that the uplink resource is a resource for a PUCCH transmission.

Example 64 is a method of wireless communication at a base station, including: transmitting one or more CSI-RSs; transmitting to a UE, control signaling to grant an uplink resource to be used for CSI reporting; transmitting to the UE, control signaling to configure at least one AI-based CSI report based on at least one first CSI-RS of the one or more CSI-RSs; transmitting, to the UE, control signaling to configure at least one non-AI-based CSI report based on at least one second CSI-RS of one or more CSI-RSs; receiving a transmission including one or more CSI reports from the UE on the uplink resource; identifying that the uplink resource for CSI part 2 is insufficient to carry the at least one AI-based CSI report and at least one non-AI-based CSI report; determining AI-based CSI report(s) and/or non-AI-based CSI report(s) in CSI part 2 are omitted from the transmission or more CSI reports; and determining or identifying a precoder to use for MIMO communications, based on the one or more CSI reports and taking the omitted AI-based CSI report(s) and/or non-AI-based CSI report(s) into account.

Example 65 may be combined with example 64 and further includes transmitting a PDSCH transmission to the UE using the precoder.

Example 66 may be combined with any of examples 64-65 and includes that the determining the precoder further includes determining or identify CSI-RS(s) to which the one or more CSI reports is/are associated based on information that the AI-based CSI report(s) and/or non-AI-based CSI report(s) are omitted, determining or identify the precoder based on the association and the one or more CSI reports.

Example 67 may be combined with any of examples 64-66 and includes that the first at least one first CSI-RS and at least one second CSI-RS can include the same CSI-RS(s) and/or different CSI-RS(s).

Example 68 may be combined with any of examples 64-67 and includes that the uplink resource is a resource for a PUSCH transmission.

Example 69 may be combined with any of examples 64-68 and includes that the uplink resource is a resource for a PUCCH transmission.

Example 70 may be combined with any of examples 64-69 and includes that the determining AI-based CSI report(s) and/or non-AI-based CSI report(s) are omitted from the transmission or the one or more CSI reports is based on a CSI omission rule.

Example 71 may be combined with any of examples 64-70 and includes that the CSI omission rule includes that the AI-based CSI report(s) and non-AI-based CSI report(s) have lower priority/priorities, and the base station determines that the AI-based CSI report(s) and non-AI-based CSI report(s) are omitted based on the low priority/priorities.

Example 72 may be combined with any of examples 64-71 and includes that the CSI omission rule includes that the AI-based CSI report(s) has lower priority/priorities than the non-AI-based CSI report(s), and the UE determines that the AI-based CSI report(s) are omitted based on the low priority/priorities.

Example 73 may be combined with any of examples 64-72 and includes that the CSI omission rule includes that the non-AI-based CSI report(s) has lower priority/priorities than the AI-based CSI report(s), and the base station determines that the AI-based CSI report(s) are omitted based on the low priority/priorities.

Example 74 is a method of wireless communication at a base station, including: transmitting a CSI-RS; transmitting to a UE control signaling to grant an uplink resource to be used for CSI reporting; receiving a CSI report from the UE on the uplink resource; identifying that the uplink resource for CSI part 2 is insufficient to carry a first PMI, a second PMI and a third PMI, which indicate a wideband precoder, compressed eigen vectors for channels with the selected wideband precoder in even subbands, and compressed eigen vectors for channels with the selected wideband precoder in odd subbands, respectively; determining one or some of the first, the second and the third PMIs in the CSI report is/are omitted; and determining or identifying a precoder to use for MIMO communications, based on the remaining PMI(s) in the CSI report.

Example 75 may be combined with example 74 and further includes transmitting a PDSCH transmission to the UE using the precoder.

Example 76 may be combined with any of examples 74-75 and includes that the base station determines one or some of the first, the second and the third PMIs in the CSI report is/are omitted, based on a CSI omission rule.

Example 77 may be combined with any of examples 74-76 and includes that the CSI omission rule comprises that the second PMI and/or third PMI have lower priority/priorities than the first PMI, and the base station determines that the second PMI and/or third PMI is/are omitted based on the low priority/priorities.

Example 78 may be combined with any of examples 74-77 and includes that the CSI omission rule comprises that the second PMI has a lower priority than the first PMI and third PMI, and the base station determines that the second PMI is omitted based on the low priority.

Example 79 may be combined with any of examples 74-78 and includes that the CSI omission rule comprises that the third PMI has a lower priority than the first PMI and second PMI, and the base station determines that the third PMI is omitted based on the low priority.

Example 80 may be combined with any of examples 74-79 and includes that the CSI omission rule comprises that the first PMI have a lower priority than the second PMI and third PMI, and the base station determines that the first PMI is omitted based on the low priority.

Example 81 may be combined with any of examples 74-80 and includes that the uplink resource is a resource for a PUSCH transmission.

Example 82 may be combined with any of examples 74-81 and includes that the uplink resource is a resource for a PUCCH transmission.

Example 83 is a method of wireless communication at a base station, including: transmitting a CSI-RS; transmitting to a UE control signaling to grant an uplink resource to be used for CSI reporting; receiving a CSI report from the UE on the uplink resource; identifying that the uplink resource for CSI part 2 is insufficient to carry a first PMI and a second PMI, which indicate a wideband precoder, and compressed eigen vectors for channels with the selected wideband precoder in all subbands, respectively; determining one or both of the first and the second PMIs or a first portion (e.g., some bits) of the second PMI is/are omitted in the CSI report; and determining or identify a precoder to use for MIMO communications, based on the remaining PMI(s) or remaining portion of the second PMI in the CSI report.

Example 84 may be combined with example 83 and includes that if the base station determines that both of the first and the second PMIs are omitted, the base station determine or identify the precoder to use for MIMO communications, based on CSI part 1 in the CSI report.

Example 85 may be combined with any of examples 83-84 and includes that the CSI part 1 includes CQI and/or RI.

Example 86 may be combined with any of examples 83-85 and further includes transmitting a PDSCH transmission to the UE using the precoder.

Example 87 may be combined with any of examples 83-86 and includes that the base station determines one or both of the first and the second PMIs or a portion of the second PMI in the CSI report is/are omitted, based on a CSI omission rule.

Example 88 may be combined with any of examples 83-87 and includes that the CSI omission rule comprises that the second PMI has a lower priority than the first PMI, and the base station determines that the second PMI is omitted based on the low priority.

Example 89 may be combined with any of examples 83-88 and includes that the CSI omission rule comprises that the first PMI has a lower priority than the second PMI, and the base station determines that the first PMI is omitted based on the low priority.

Example 90 may be combined with any of examples 83-89 and includes that the CSI omission rule comprises that the first portion of the second PMI has a lower priority than the remaining portion (e.g., the other bits) of the second PMI, and the base station determines that the first portion is omitted based on the low priority.

Example 91 may be combined with any of examples 83-90 and includes that the first portion and remaining portion are determined based on a single AL/ML model.

Example 92 may be combined with any of examples 83-91 and includes that the first portion and remaining portion are determined based on different AL/ML models.

Example 93 may be combined with any of examples 83-92 and includes that the first portion and remaining portion are predefined or configured by the base station via RRC signaling.

Example 94 may be combined with any of examples 83-93 and includes that the uplink resource is a resource for a PUSCH transmission.

Example 95 may be combined with any of examples 83-94 and includes that the uplink resource is a resource for a PUCCH transmission.

Example 96 is a method of wireless communication at a base station, including: transmitting a CSI-RS; transmitting to a UE control signaling to grant an uplink resource to be used for CSI reporting; determining bit-width for a set of PMIs for AI-based CSI report based on at least one AI/ML model(s) and the CSI-RS, which indicate the compressed eigen vectors for channels in all subband; identifying that the PMI with maximum bit-width that can fit maximum payload size for the uplink resource for CSI part 2 on the uplink resource to the base station, and determining or identifying a precoder to use for MIMO communications, based on the decoded PMI in AI-based CSI report.

Example 97 may be combined with example 96 and includes that the AI/ML models may be predefined or configured by RRC signaling.

Example 98 may be combined with any of examples 96-97 and includes that the uplink resource is a resource for a PUSCH transmission.

Example 99 may be combined with any of examples 96-98 and includes that the uplink resource is a resource for a PUCCH transmission.

Example 100 is a method of wireless communication at a base station, including: transmitting a CSI-RS; transmitting to a UE control signaling to grant an uplink resource to be used for CSI reporting; receiving a CSI report from the UE on the uplink resource, identifying that the uplink resource for CSI part 2 is insufficient to carry a first PMI and a second PMI, wherein the first PMI is an AI-based CSI report based on the CSI-RS and indicates the compressed eigen vectors for channels in all subbands, and the second PMI is a non-artificial intelligence (non-AI)-based CSI report based on the CSI-RS; and determining or identifying a precoder to use for MIMO communications, based on the second PMI and a codebook on the uplink resource.

Example 101 may be combined with example 100 and includes that the codebook may be predefined or configured by RRC signaling.

Example 102 may be combined with any of examples 100-101 and includes that the uplink resource is a resource for a PUSCH transmission.

Example 103 may be combined with any of examples 100-102 and includes that the uplink resource is a resource for a PUCCH transmission.

Example 104 is a method of wireless communication at a UE, including: communicating with a base station; and performing CSI measurements and/or AI-based CSI reporting, based on at least one first CSI processing capability for AI-based CSI reporting.

Example 105 may be combined with example 104 and includes that the UE receives at least one reference signal from the base station and performs the CSI measurement(s) based on the at least one reference signal.

Example 106 may be combined with any of examples 104-105 and includes that the performing the AI-based CSI reporting further includes: obtaining AI-based CSI reports from the CSI measurements and AI or ML model(s); and transmitting to the base station the AI-based CSI reports, wherein the AI-based CSI reports include periodic CSI, semi-persistent CSI, aperiodic CSI, any latency classes, codebook types, and/or beam report(s).

Example 107 may be combined with any of examples 104-106 and includes that the at least one reference signal includes CSI-RS(s) and/or SSB(s).

Example 108 may be combined with any of examples 104-107 and includes that the UE transmits the at least one first CSI processing capability to the base station.

Example 109 may be combined with any of examples 104-108 and includes that the at least one first CSI processing capability indicates that the UE supports AI-based CSI processing.

Example 110 may be combined with any of examples 104-109 and includes that the UE communicates with the base station on one or more frequency band(s) and the at least one first CSI processing capability includes a capability indicating the (maximum) number of AI-based CSI reports for which the UE is capable of measuring and processing reference signal(s) simultaneously for each of the frequency band(s) or each component carrier (CC) in the frequency band(s).

Example 111 may be combined with any of examples 104-110 and includes that the UE communicates with the base station on one or more frequency band(s) and the at least one first CSI processing capability includes a capability indicating the (maximum) number of AI-based CSI reports for which the UE is capable of measuring and processing reference signal(s) simultaneously for all of the frequency band(s) or all CC(s) in the frequency band(s).

Example 112 may be combined with any of examples 104-111 and includes that the UE has a plurality of CSI processing units (CPUs) where some or all are used by the UE to perform the CSI measurements and/or AI-based CSI reporting, and determines a CPU occupancy for each of the CPUs while performing the CSI measurement(s) and/or AI-based CSI reporting.

Example 113 may be combined with any of examples 104-112 and includes that the UE deprioritizes at least one CSI measurement and/or at least one AI-based CSI report based on the at least one first CSI capability and CPU occupancy/occupancies and transmits outdated CSI for the at least one AI-based CSI report.

Example 114 may be combined with any of examples 104-113 and includes that the at least one first CSI processing capability indicates that the UE supports AI-based CSI processing.

Example 115 may be combined with any of examples 104-114 and includes that the at least one first CSI processing capability includes a capability indicating a minimal processing delay for AI-based CSI reporting.

Example 116 may be combined with any of examples 104-115 and includes that the at least one first CSI processing capability includes a capability indicating a minimal processing delay for AI-based CSI reporting for FR1.

Example 117 may be combined with any of examples 104-116 and includes that the at least one first CSI processing capability includes a capability indicating a minimal processing delay for AI-based CSI reporting for FR2.

Example 118 may be combined with any of examples 104-117 and includes that the at least one first CSI processing capability includes a capability indicating a minimal processing delay for AI-based CSI reporting for (each of) one or more band(s), (each of) one or more band combination(s), each band in the band combination(s), or (each of) one or more frequency ranges.

Example 119 may be combined with any of examples 104-118 and includes that the at least one first CSI processing includes a capability indicating whether the AI based CSI processing shares CPU(s) for non-AI based processing.

Example 120 may be combined with any of examples 104-119 and includes that the at least one first CSI processing includes a capability indicating the number of CPUs (e.g., Type2 CPUs) shared for AI-based CSI reporting and non-AI-based reporting.

Example 121 may be combined with any of examples 104-120 and includes that the at least one first CSI processing includes a capability indicating the number of CPUs (e.g., Type2 CPUs) shared for AI-based CSI reporting and non-AI-based reporting for (each of) one or more band(s), (each of) one or more band combination(s), each band in the band combination(s), or (each of) one or more frequency ranges.

Example 122 may be combined with any of examples 104-121 and includes that the UE transmits to the base station an on/off duration for the Type2 CPU.

Example 123 may be combined with any of examples 104-122 and includes that the UE transmits to the base station a periodic or semi-persistent AI-based CSI report (excluding an initial semi-persistent AI-based CSI report on PUSCH after the PDCCH triggering the report), and the AI-based CSI report occupies Type2 CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report.

Example 124 may be combined with any of examples 104-123 and includes that the UE transmits to the base station an aperiodic AI-based CSI report that occupies Type2 CPU(s) from the first symbol after the PDCCH triggering the CSI report until the last symbol of the scheduled PUSCH carrying the report.

Example 125 may be combined with any of examples 104-124 and includes that the UE transmits to the base station an initial semi-persistent AI based CSI report on PUSCH after the PDCCH trigger, and the initial semi-persistent AI-based CSI report occupies Type2 CPU(s) from the first symbol after the PDCCH until the last symbol of the scheduled PUSCH carrying the report.

Example 126 may be combined with any of examples 104-125 and includes that the UE determines a Type2 CPU occupied after X symbols after the first/last symbol of the earliest/latest CMR or IMR, until Y symbols before the first/last symbol of PUSCH/PUCCH used for AI based CSI report.

Example 127 may be combined with any of examples 104-126 and includes that X and Y are predefined or reported by UE capability.

Example 128 may be combined with any of examples 104-127 and includes that each of the AI-based CSI reports takes both Type1 and Type2 CPU.

Example 129 may be combined with any of examples 104-128 and includes that the UE transmits to the base station a periodic or semi-persistent CSI report (excluding an initial semi-persistent CSI report on PUSCH after the PDCCH triggering the report) that occupies Type1 and Type2 CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report

Example 130 may be combined with any of examples 104-129 and includes that the UE transmits to the base station an aperiodic AI-based CSI report occupies Type1 and Type2 CPU(s) from the first symbol after the PDCCH triggering the CSI report until the last symbol of the scheduled PUSCH carrying the report.

Example 131 may be combined with any of examples 104-130 and includes that the UE transmits to the base station an initial semi-persistent AI-based CSI report on PUSCH after the PDCCH trigger, and the AI-based occupies T % pel and Type2 CPU(s) from the first symbol after the PDCCH until the last symbol of the scheduled PUSCH carrying the report.

Example 132 may be combined with any of examples 104-131 and includes that the Type1 CPU is occupied excluding the duration when a Type2 CPU is occupied.

Example 133 may be combined with any of examples 104-132 and includes that the UE reports valid CSI for the N_{CPU,2} AI-based CSI report with higher priority, where N_{CPU,2} is the maximum number of Type2 CPUs.

Example 134 may be combined with any of examples 104-133 and includes that the UE reports to the base station valid CSI for the min{N_{CPU,1}−n_{CPU,1},N_{CPU,2}} AI-based CSI report with higher priority, where N_{CPU,1} is the maximum number of Type1 CPUs, n_{CPU,1} is the number of CPUs used by other higher priority non-AI based CSI report, and N_{CPU,2} is the maximum number of Type2 CPUs.

Example 135 may be combined with any of examples 104-134 and includes that the UE reports to the base station outdated CSI for other triggered AI-based CSI report(s).

Example 136 may be combined with any of examples 104-135 and includes that the capability includes parameters Z and Z′ for AI based CSI report, where Z indicates the duration between DCI and the first uplink symbol to carry the corresponding AI based CSI report(s) including the effect of the timing advance, and Z′ indicates the duration between the DCI and the first uplink symbol to carry the n-th AI based CSI report including the effect of the timing advance.

Example 137 may be combined with any of examples 104-136 and includes that the UE determines the parameters Z and Z′ based on the whether UE supports Type2 CPU or not for AI based CSI report.

Example 138 may be combined with any of examples 104-137 and includes that the UE includes the parameters Z and Z′ for each support neural network type.

Example 139 may be combined with any of examples 104-138 and includes that the parameters Z and Z′ for one AI-based CSI report is predefined.

Example 140 may be combined with any of examples 104-139 and includes that the capability indicates parameters uNZ and uNZ′ and the UE reports N AI-based CSI reports for AI-based CSI reporting to the base station, based on the parameters defined uNZ and uNZ′, where u is predefined, configured by the base station in higher layer signaling to the UE, or reported by the UE in a capability sent to the base station.

Example 141 may be combined with any of examples 104-140 and includes that the UE receives a DCI from the base station, and if a scheduling offset in the DCI does not meet the minimal processing delay indicated in the parameters Z or Z′, the UE ignores the DCI if no HARQ-ACK or data is transmitted on the PUSCH scheduled by the DCI.

Example 142 may be combined with any of examples 104-141 and includes that the UE receives a DCI from the base station, and if the scheduling offset does not meet the minimal processing delay indicated in the parameters Z or Z, the UE report to the base station outdated CSI for all the triggered CSI report(s).

Example 143 may be combined with any of examples 104-142 and includes that if the scheduling offset does not meet the minimal processing delay indicated in the parameters Z or Z′, the UE reports to the base station outdated CSI for the triggered CSI report that does not meet the minimal processing delay indicated in the parameters Z or Z′.

Example 144 may be combined with any of examples 104-143 and further includes performing CSI measurement(s) and/or artificial intelligence non-AI-based CSI reporting, based on at least one second CSI processing capability for non-AI-based CSI reporting.

Example 145 may be combined with any of examples 104-144 and includes that the UE receives at least one reference signal from the base station and performs the CSI measurement(s) based on the at least one reference signal.

Example 146 may be combined with any of examples 104-145 and further includes obtaining non-AI-based CSI report(s) from the CSI measurement(s); and transmitting to the base station the non-AI-based CSI report(s), where the non-AI-based CSI report(s) include periodic CSI, semi-persistent CSI, aperiodic CSI, any latency classes, codebook types, and/or beam report(s).

Example 147 may be combined with any of examples 104-146 and includes that the at least one reference signal includes CSI-RS(s) and/or SSB(s).

Example 148 may be combined with any of examples 104-147 and includes that the UE transmits the at least one second CSI processing capability to the base station.

Example 149 may be combined with any of examples 104-148 and includes that the at least one second CSI processing capability indicates that the UE supports non-AI-based CSI processing.

Example 150 may be combined with any of examples 104-149 and includes that the UE communicates with the base station on one or more frequency band(s) and the at least one second CSI processing capability includes a capability indicating the (maximum) number of non-AI-based CSI report(s) for which the UE is capable of measuring and processing reference signal(s) simultaneously for each of the frequency band(s).

Example 151 may be combined with any of examples 104-150 and includes that the UE communicates with the base station on one or more frequency band(s) and the at least one second CSI processing capability includes a capability indicating the (maximum) number of non-AI-based CSI report(s) for which the UE is capable of measuring and processing reference signal(s) simultaneously for all of the frequency band(s).

Example 152 may be combined with any of examples 104-151 and includes that the UE determines CPU occupancy while performing the CSI measurement(s) and/or non-AI-based CSI reporting.

Example 153 may be combined with any of examples 104-152 and includes that the at least one second CSI processing capability includes a capability indicating a minimal processing delay for non-AI-based CSI reporting.

Example 154 may be combined with any of examples 104-153 and includes that the UE uses a portion of the CPUs to perform the CSI measurements and/or AI-based CSI reporting, and determines a CPU occupancy for each of the portion of the CPUs while performing the CSI measurement(s) and/or non-AI-based CSI reporting, and includes that the CPUs are shared for AI-based CSI reporting and non-AI-based CSI reporting.

Example 155 may be combined with any of examples 104-154 and includes that the UE has a plurality of CPUs for non-AI-based CSI reporting, where some or all are used by the UE to perform the CSI measurements and/or non-AI-based CSI reporting, and determines a CPU occupancy for each of the CPUs while performing the CSI measurement(s) and/or non-AI-based CSI reporting, and includes that the UE has a first set of CPUs dedicated for AI-based CSI reporting and a second set of CPUs dedicated for non-AI-based CSI reporting.

Example 156 may be combined with any of examples 104-155 and includes that the UE deprioritizes at least one CSI measurement and/or at least one non-AI-based CSI report based on the at least one first CSI capability, at least one second CSI capability and/or CPU occupancy/occupancies and transmits outdated CSI for the at least one non-AI-based CSI report, an includes that the UE determines that the AI-based CSI report has a higher priority than the non-AI-based CSI report, and includes that when the UE has no sufficient CPUs to perform CSI measurements and/or reporting for AI-based CSI reporting and non-AI-based CSI reporting, the UE transmits to the base station outdated CSI for a non-AI-based CSI report for which the UE does not allocate a CPU.

Example 157 may be combined with any of examples 104-156 and includes that the UE deprioritizes at least one CSI measurement and/or at least one AI-based CSI report based on the at least one first CSI capability, at least on second CSI capability and/or CPU occupancy/occupancies and transmits outdated CSI for the at least one AI-based CSI report, and includes that the UE determines that the AI-based CSI report has a lower priority than the non-AI-based CSI report, and includes that when the UE has no sufficient CPUs to perform CSI measurements and/or reporting for AI-based CSI reporting and non-AI-based CSI reporting, the UE transmits to the base station outdated CSI for a AI-based CSI report for which the UE does not allocate a CPU.

Example 158 is a method of wireless communication at a base station, including: communicating with a UE; and receiving at least one first CSI processing capability for AI-based CSI reporting from the UE, a core network or another base station; and configuring the UE to perform CSI measurement(s) and/or AI-based CSI reporting, based on the at least one first CSI processing capability.

Example 159 may be combined with example 158 and includes that the base station transmits at least one reference signal to the UE and receives from the UE AI-based CSI report(s) associated to the at least one reference signal, wherein the AI-based CSI reports include periodic CSI, semi-persistent CSI, aperiodic CSI, any latency classes, codebook types, and/or beam report(s).

Example 160 may be combined with any of examples 158-159 and includes that the at least one reference signal includes CSI-RS(s) and/or SSB(s).

Example 161 may be combined with any of examples 158-160 and includes that the base station communicates with the UE on one or more frequency band(s) and the at least one first CSI processing capability includes a capability indicating the (maximum) number of AI-based CSI report(s) for which the UE is capable of measuring and processing reference signal(s) simultaneously for each of the frequency band(s).

Example 162 may be combined with any of examples 158-161 and includes that the base station communicates with the UE on one or more frequency band(s) and the at least one first CSI processing capability includes a capability indicating the (maximum) number of AI-based CSI report(s) for which the UE is capable of measuring and processing reference signal(s) simultaneously for all of the frequency band(s).

Example 163 may be combined with any of examples 158-162 and includes that the base station configures the UE to perform CSI measurement(s) and/or non-AI-based CSI reporting.

Example 164 may be combined with any of examples 158-163 and includes that the base station receives at least one second CSI processing capability from the UE, CN or another base station, and configures the UE to perform the CSI measurement(s) and/or non-AI-based CSI reporting, based on the at least one second CSI processing capability.

Example 165 may be combined with any of examples 158-164 and includes that the performing the non-AI-based CSI reporting further includes: receiving non-AI-based CSI report(s) from the UE, wherein the non-AI-based CSI report(s) include periodic CSI, semi-persistent CSI, aperiodic CSI, any latency classes, codebook types, and/or beam report(s).

Example 166 may be combined with any of examples 158-165 and includes that the at least one second CSI processing capability indicates that the UE supports non-AI-based CSI processing.

Example 167 may be combined with any of examples 158-166 and includes that the base station communicates with the UE on one or more frequency band(s) and the at least one second CSI processing capability includes a capability indicating the (maximum) number of non-AI-based CSI report(s) for which the UE is capable of measuring and processing reference signal(s) simultaneously for each of the frequency band(s).

Example 168 may be combined with any of examples 158-167 and includes that the base station communicates with the UE on one or more frequency band(s) and the at least one second CSI processing capability includes a capability indicating the (maximum) number of non-AI-based CSI report(s) for which the UE is capable of measuring and processing reference signal(s) simultaneously for all of the frequency band(s).

Example 169 may be combined with any of examples 158-168 and includes that the at least one second CSI processing capability includes a capability indicating a minimal processing delay for non-AI-based CSI reporting.

Example 170 may be combined with any of examples 158-169 and includes that the at least one second CSI processing capability does not include a capability indicating a minimal processing delay for non-AI-based CSI reporting.

Example 171 is an apparatus for wireless communication for implementing a method as in any of examples 1-170.

Example 172 is an apparatus for wireless communication including means for implementing a method as in any of examples 1-170.

Example 173 is a non-transitory computer-readable medium storing computer executable code, the code when executed by at least one processor causes the at least one processor to implement a method as in any of examples 1-170.

1-19. (canceled)

20. A method of wireless communication at a user equipment (UE), comprising:
receiving, from a network entity, a channel state information (CSI) report configuration, the CSI report configuration configuring a first CSI report associated with machine-learning (ML)-based CSI and a second CSI report associated with non-ML-based CSI;
receiving, from the network entity, a plurality of CSI-reference signals (CSI-RSs) for obtaining the ML-based CSI using a first CSI processing unit (CPU) and the non-ML-based CSI using a second CPU;
omitting at least a portion of the first CSI report or a portion of the second CSI report when a total payload size of a CSI report transmission exceeds a threshold; and
transmitting, to the network entity and based on the omitting, the CSI report transmission including at least a remaining portion of the first CSI report or a remaining portion of the second CSI report.

21. The method of claim 20, wherein the omitting is based on at least one of:
an omitted portion having a lower priority than a remaining portion; or
the omitted portion belonging to a CSI report that has a lower priority than another CSI report to which the remaining portion belongs.

22. The method of claim 20, wherein the omitting comprises:
omitting a first portion of the first CSI report; and
omitting a second portion of second CSI report, the second CSI report being included in the CSI report transmission.

23. The method of claim 20, wherein the omitting comprises:
dropping the first CSI report; and
replacing the dropped first CSI report with a replacement CSI report that is not based on an ML model, the at least one replacement CSI report being included in the CSI report transmission.

24. The method of claim 23, wherein the ML model is a predetermined ML model or selected based on a predefined protocol.

25. The method of claim 20, wherein the transmitting the CSI report transmission, comprises:
transmitting, to the network entity, an indication of the omitted portion.

26. The method of claim 20, further comprising: transmitting, to the network entity, a UE capability message that indicates at least one of:
a capability for a minimum CSI report processing delay,
a maximum number of Type 1 CPUs, or
a maximum number of Type 2 CPUs.

27. The method of claim 20, further comprising: receiving, from the network entity, a CPU configuration indicating a type of the first CPU.

28. The method of claim 20, further comprising: receiving a triggering indication to measure the plurality of CSI-RSs for the CSI report transmission.

29. The method of claim 20, further comprising: measuring the plurality of CSI-RSs to obtain the ML-based CSI and the non-ML-based CSI based on a priority of the first CSI report and the second CSI report.

30. The method of claim 20, further comprising receiving, from the network entity, a radio resource control (RRC) configuration for at least one of:
a ML model for compressing CSI for the first CSI report; or
a codebook and a number of beams for a wideband precoder for CSI compression.

31. A method of wireless communication at a network entity, comprising:
transmitting, to a user equipment (UE), a channel state information (CSI) report configuration, the CSI report configuration configuring a first CSI report associated with machine-learning (ML)-based CSI and a second CSI report associated with non-ML-based CSI;
transmitting, to the UE, a plurality of CSI-reference signals (CSI-RSs) for obtaining the ML-based CSI using a first CSI processing unit (CPU) and the non-ML-based CSI using a second CPU; and
receiving, from the UE, a CSI report transmission including at least a remaining portion of the first CSI report or a remaining portion of the second CSI report, the remaining portion being obtained based on an omission of at least a portion of the first CSI report or a portion of the second CSI report when a total payload size of the CSI report transmission exceeds a threshold.

32. The method of claim 31, wherein the receiving the CSI report transmission, comprises:
receiving, from the UE, an indication of the omitted portion.

33. The method of claim 31, further comprising: receiving, from the UE, a UE capability message that indicates at least one of:
a capability for a minimum CSI report processing delay,
a maximum number of Type 1 CPUs, or
a maximum number of Type 2 CPUs.

34. The method of claim 31, further comprising: transmitting, to the UE, a CPU configuration indicating a type of the first CPU.

35. The method of claim 31, further comprising: transmitting a triggering indication to measure the plurality of CSI-RSs for the CSI report transmission.

36. An apparatus for wireless communication at a user equipment (UE), comprising:
a memory; and
at least one processor coupled to the memory, the at least one processor configured to execute instructions stored in the memory to cause the apparatus to:
receive, from a network entity, a channel state information (CSI) report configuration, the CSI report configuration configuring a first CSI report associated with machine-learning (ML)-based CSI and a second CSI report associated with non-ML-based CSI;
receive, from the network entity, a plurality of CSI-reference signals (CSI-RSs) for obtaining the ML-based CSI using a first CSI processing unit (CPU) and the non-ML-based CSI using a second CPU;
omit at least a portion of the first CSI report or a portion of the second CSI report when a total payload size of a CSI report transmission exceeds a threshold; and
transmit, to the network entity and based on the omission, a CSI report transmission including at least a remaining portion of the first CSI report or a remaining portion of the second CSI report.

37. The apparatus of claim 36, wherein the transmitting the CSI report transmission, comprises:
transmitting, to the network entity, an indication of the omitted portion.

38. The apparatus of claim 36, wherein the processor is further configured to cause the apparatus to transmit, to the network entity, a UE capability message that indicates at least one of:
a capability for a minimum CSI report processing delay,
a maximum number of Type 1 CPUs, or
a maximum number of Type 2 CPUs.

39. The apparatus of claim 36, wherein the processor is further configured to cause the apparatus to receive, from the network entity, a CPU configuration indicating a type of the first CPU.
